(19) United States
(12) Patent Application Publication
(10) Pub. No.: US 2026/0235046 A1
(43) Pub. Date: Aug. 13, 2026

(54) LUBRICATION SYSTEM FOR A FAN ASSEMBLY OF A TURBINE ENGINE

(71) Applicants: General Electric Company, Evendale, OH (US); GE Aerospace Poland Sp. z o.o., Warsaw (PL)

(72) Inventors: Ethan Patrick O'Connor, Hamilton, OH (US); Nicholas M. Daggett, Camden, ME (US); Miroslaw Sobaniec, Grodzisk Mazowiecki (PL); Marek Stegienko, Warsaw (PL); Mariusz Staszak, Warsaw (PL)

(21) Appl. No.: 19/278,457

(22) Filed: Jul. 23, 2025

Related U.S. Application Data
(60) Provisional application No. 63/755,847, filed on Feb. 7, 2025.
(60) Provisional application No. 63/757,200, filed on Feb. 11, 2025.

(51) Int. Cl. F01D 25/18; F01D 5/02; F01D 25/16

(52) U.S. Cl. CPC F01D 25/18; F01D 5/02; F01D 25/162; F05D 2260/602

(57) ABSTRACT

A turbine engine includes a turbo-engine, a fan section defining a sump cavity, and a lubrication system. The fan section includes a fan actuation system and a fan assembly defining a fan assembly centerline axis that includes a fan shaft, a fan blade hub coupled to the fan shaft, and a plurality of fan blades rotationally coupled to the fan blade hub. The fan blade hub partially defines the sump cavity such that the sump cavity rotates with the fan blade hub about the fan assembly centerline axis. The fan actuation system includes a plurality of fan blade trunnions and is configured to rotate the plurality of fan blades relative to the fan blade hub. The lubrication system provides a lubrication fluid to the sump cavity such that, during operation of the turbine engine, the lubrication fluid flows through the sump cavity to lubricate the fan actuation system.

### CROSS REFERENCE TO RELATED APPLICATIONS

This application claims the benefit of priority of U.S. Provisional Patent Application No. 63/755,847, filed on Feb. 7, 2025, and of U.S. Provisional Patent Application No. 63/757,200, filed on Feb. 11, 2025, the contents of each of which is hereby incorporated by reference herein in its entirety.

### TECHNICAL FIELD

The present disclosure relates generally to fan assemblies of turbine engines, and particularly, to lubrication systems for fan assemblies of turbine engines.

### BACKGROUND

Turbine engines, for example, for aircraft, generally include a fan section with a fan assembly and a turbo-engine arranged in flow communication with one another. Some fan assemblies of turbine engines include a fan actuation system for actuating the fan blades and that require lubrication of one or more components thereof.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, or structurally similar elements.

FIG. 1 is a schematic view of an unducted, three-stream, gas turbine engine for an aircraft, that may incorporate one or more embodiments of the present disclosure.

FIG. 2 is a schematic, cross-sectional view of an exemplary turbine engine for an aircraft, taken along a longitudinal centerline axis of the turbine engine, that may incorporate one or more embodiments of the present disclosure.

FIG. 3 is an enlarged, detailed, cross-sectional view of a fan assembly, taken at detail “3” of FIG. 2, according to the present disclosure.

FIG. 4 is an enlarged, detailed, cross-sectional view of the fan assembly, taken at detail “4” of FIG. 3, according to the present disclosure.

FIG. 5 is a schematic representation of an exemplary lubrication system of the turbine engine of FIGS. 2 to 4, according to the present disclosure.

FIG. 6 is a schematic, cross-sectional view of another exemplary fan assembly of the turbine engine of FIGS. 2 to 4, according to another embodiment of the present disclosure.

FIG. 7 is a schematic, aft-looking view of a plurality of fins of the fan assembly of FIG. 6, according to the present disclosure.

FIG. 8 is a schematic, cross-sectional view of another exemplary fan assembly and lubrication system of the turbine engine of FIGS. 2 to 4, according to another embodiment of the present disclosure.

FIG. 9 is a schematic, cross-sectional view of another exemplary fan assembly and lubrication system of the turbine engine of FIGS. 2 to 4, according to another embodiment of the present disclosure.

FIG. 10 is a schematic, cross-sectional view of another exemplary fan assembly and lubrication system of the turbine engine of FIGS. 2 to 4, according to another embodiment of the present disclosure.

FIG. 11 is a schematic, cross-sectional view of another exemplary fan assembly and lubrication system of the turbine engine of FIGS. 2 to 4, according to another embodiment of the present disclosure.

FIG. 12 is a schematic, cross-sectional view of another exemplary fan assembly and lubrication system of the turbine engine of FIGS. 2 to 4, according to another embodiment of the present disclosure.

FIG. 13 is a schematic, cross-sectional view of another exemplary fan assembly and lubrication system of the turbine engine of FIGS. 2 to 4, according to another embodiment of the present disclosure.

FIG. 14 is a schematic, cross-sectional view of another exemplary fan assembly and lubrication system of the turbine engine of FIGS. 2 to 4, according to another embodiment of the present disclosure.

FIG. 15 is a schematic, cross-sectional view of another exemplary fan assembly and lubrication system of the turbine engine of FIGS. 2 to 4, according to another embodiment of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” “third,” “fourth,” and “fifth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and refer to the normal operational attitude of the turbine engine or vehicle. More particularly, forward and aft are used herein with reference to a direction of travel of the vehicle and a direction of propulsive thrust of the gas turbine engine.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components or the systems or manufacturing the components or the systems. For example, the approximating language may refer to being within a one, two, four, ten, fifteen, or twenty percent margin in either individual values, range(s) of values or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Conventionally, an aircraft engine (e.g., a turbine engine) may include a fan assembly as a propulsion source. The fan assembly may be implemented, for example, in a ducted fan turbine engine or in an unducted fan turbine engine. The fan assembly may include a fan actuation system that generally includes a plurality of fan blades connected to a fan blade hub that is driven by a drive shaft. Each fan blade is generally rotationally mounted to the fan blade hub so that the fan blade can be rotated about a pitch change axis of the blade in order to change an angle of attack of the fan blade. During flight operations, the rotating of the fan blades to change the angle of attack results in aerodynamic and mechanical twisting in the fan blades, which imparts a torque moment to fan blade trunnions mounting the fan blades to the fan blade hub. The torque moment imparted to the fan blade trunnions mounting the fan blades, in turn, imparts an axial force to an actuator to which the fan blade trunnions are connected. To counteract the torque imparted to the fan blade trunnions, the fan assembly may further include a counterweight system.

Various components of the fan actuation system, e.g., the fan blade trunnions themselves and the fan blade trunnion bearings supporting the fan blades relative to the fan blade trunnions, require lubrication to reduce friction during continued operation of the turbine engine. Some conventional fan assemblies utilize grease packed within sealed cavities surrounding the fan blade trunnion bearings. However, such grease packs require disassembly of the fan assembly to replace the grease. Further, grease weighs significantly more than lubrication fluid (e.g., oil), which can reduce performance of the turbine engine. Other conventional fan assemblies utilize oil contained within the sealed cavities. However, the oil within the seal cavities can absorb heat from the fan assembly during continued operation of the turbine engine, which can result in early degradation of the oil with decreased lubricating properties of the oil.

Accordingly, the present disclosure provides for an improved lubrication system for a fan assembly of a turbine engine that lubricates one or both of a fan actuation system and a counterweight system of the fan assembly. Particularly, in some embodiments, the lubrication system provides lubrication fluid down a centerline axis of the turbine engine, which waterfalls through a sump cavity containing the fan actuation system and the counterweight system, lubricating components of the fan actuation system and the counterweight system. The lubrication fluid also fills cavities that house the fan blade trunnion bearings and the counterweight trunnion bearings of the fan actuation system and the counterweight system, respectively. When the cavities fill, excess lubrication fluid waterfalls to a scavenge feature. This configuration can utilize current oil systems of turbine engines and allows for the fan assembly to not have to carry the weight of grease in the system or have a large reservoir of stagnant oil. The fan assembly also provides an additional heat sink to remove heat from the lubrication system. Thus, flow of lubrication fluid can be increased through the sump cavity to reject more heat. In some embodiments, rotating housing structures of the fan assembly may be configured as functional heat sinks by incorporating certain materials and features such as fins. At the same time, addition of heat to the lubrication fluid from the turbine engine also keeps the sump cavity warm. This improves actuation of the fan actuation system and helps to reduce friction at above ground altitudes.

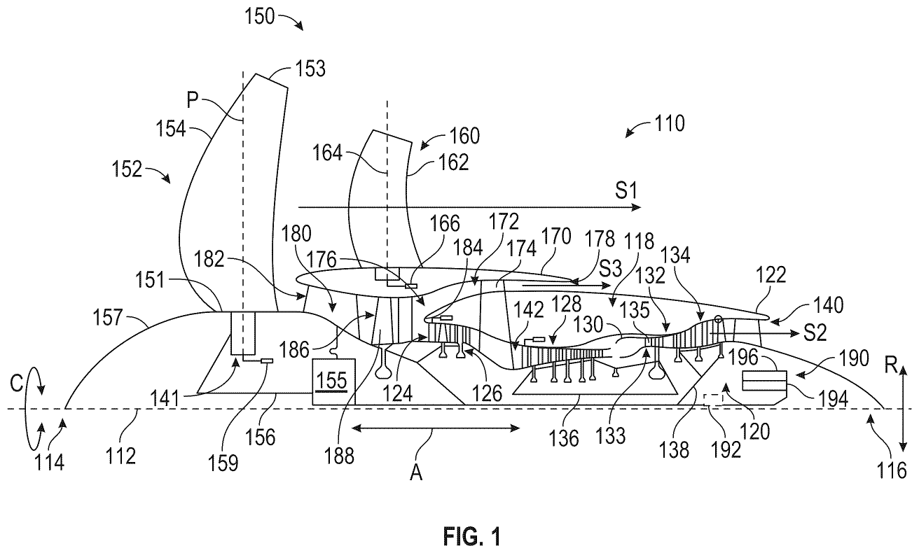

Referring now to the drawings, FIG. 1 is a schematic view of an unducted, three-stream, gas turbine engine 110 for an aircraft, that may incorporate one or more embodiments of the present disclosure. In particular, the gas turbine engine 110 is a “three-stream engine” in that its architecture provides three distinct streams (labeled S1, S2, and S3) of thrust-producing airflow during operation, as detailed further below. Although further described below with reference to an unducted gas turbine engine, the present disclosure is also applicable to turbomachinery, in general, including turbojet, turboprop, and turboshaft gas turbine engines, including marine and industrial turbine engines and auxiliary power units. In addition, the present disclosure is not limited to unducted fan type gas turbine engines such as that shown in FIG. 1, but can be implemented in ducted fan type gas turbine engines. Further, the present disclosure may be implemented in propeller driven aircraft engines other than gas turbine engines (e.g., in reciprocating (piston) aircraft engines).

As shown in FIG. 1, the gas turbine engine 110 defines an axial direction A, a radial direction R, and a circumferential direction C. Moreover, the gas turbine engine 110 defines a centerline axis 112 that extends along the axial direction A. In general, the axial direction A extends parallel to the centerline axis 112, the radial direction R extends outward from, and inward to, the centerline axis 112 in a direction orthogonal to the axial direction A, and the circumferential direction C extends three hundred sixty degrees (360°) around the centerline axis 112. The gas turbine engine 110 extends between a forward end 114 and an aft end 116, e.g., along the axial direction A.

The gas turbine engine 110 includes a core engine 120 and a fan assembly 150 positioned upstream thereof. Generally, the core engine 120 includes, in serial flow order, a compressor section, a combustion section, a turbine section, and an exhaust section. Particularly, as shown in FIG. 1, the core engine 120 includes an engine core 118 and a core cowl 122 that annularly surrounds the core engine 120. The core engine 120 and core cowl 122 define a core inlet 124 having an annular shape. The core cowl 122 further encloses and supports a low pressure (LP) compressor 126 (also referred to as a booster) for pressurizing the air that enters the core engine 120 through core inlet 124. A high pressure (HP) compressor 128 receives pressurized air from the LP compressor 126 and further increases the pressure of the air. The pressurized air flows downstream to a combustor 130 where fuel is injected into the pressurized air and ignited to raise the temperature and the energy level of the pressurized air, thereby generating combustion gases.

The combustion gases flow from the combustor 130 downstream to a high pressure (HP) turbine 132. The HP turbine 132 drives the HP compressor 128 through a first shaft, also referred to as a high pressure (HP) shaft 136 (also referred to as a “high speed shaft”). In this regard, the HP turbine 132 is drivingly coupled with the HP compressor 128. Together, the HP compressor 128, the combustor 130, and the HP turbine 132 define the engine core 118. The combustion gases then flow to a power turbine or low pressure (LP) turbine 134. The LP turbine 134 drives the LP compressor 126 and components of the fan assembly 150 through a second shaft, also referred to as a low pressure (LP) shaft 138 (also referred to as a “low speed shaft”). In this regard, the LP turbine 134 is drivingly coupled with the LP compressor 126 and components of the fan assembly 150. The LP shaft 138 is coaxial with the HP shaft 136 in the embodiment of FIG. 1. After driving each of the HP turbine 132 and the LP turbine 134, the combustion gases exit the core engine 120 through a core exhaust nozzle 140. The core engine 120 defines a core flowpath, also referred to as a core duct 142, that extends between the core inlet 124 and the core exhaust nozzle 140. The core duct 142 is an annular duct positioned generally inward of the core cowl 122 along the radial direction R.

The fan assembly 150 includes a primary fan 152. For the embodiment of FIG. 1, the primary fan 152 is an open rotor fan, also referred to as an unducted fan. However, in other embodiments, the primary fan 152 may be ducted, e.g., by a fan casing or a nacelle circumferentially surrounding the primary fan 152. The primary fan 152 includes an array of fan blades 154 (only one shown in FIG. 1). The fan blades 154 are rotatable about the centerline axis 112 via a fan shaft 156. As shown in FIG. 1, the fan shaft 156 is coupled with the LP shaft 138 via a speed reduction gearbox, also referred to as a gearbox assembly 155, e.g., in an indirect-drive configuration. The gearbox assembly 155 is shown schematically in FIG. 1. The gearbox assembly 155 includes a plurality of gears for adjusting the rotational speed of the fan shaft 156 and, thus, the primary fan 152 relative to the low-speed shaft 138 to a more efficient rotational fan speed. The gearbox assembly may have a gear ratio of 4:1 to 12:1, or 7:1 to 12:1, or 4:1 to 10:1, or 5:1 to 9:1, or 6:1 to 9:1, and may be configured in an epicyclic star or planet gear configuration. In some embodiments, the gearbox may be a single stage or compound gearbox.

The fan blades 154 can be arranged in equal spacing around the centerline axis 112. Each fan blade 154 has a root 151 and a tip 153 and a span defined therebetween. Each fan blade 154 defines a blade pitch axis P. For the embodiment of FIG. 1, each fan blade 154 of the primary fan 152 is rotatable about their respective blade pitch axis P, e.g., in unison with one another. A fan actuation system 141 controls one or more actuators 159 to pitch the fan blades 154 about their respective blade pitch axis P. The fan actuation system 141 is disposed within a propulsor hub 157 that is rotatable and aerodynamically contoured to promote an airflow through the fan blades 154. In other embodiments, each fan blade 154 is fixed or is unable to be pitched about the blade pitch axis P.

The fan assembly 150 further includes a fan guide vane array 160 that includes fan guide vanes 162 (only one shown in FIG. 1) disposed around the centerline axis 112. For the embodiment of FIG. 1, the fan guide vanes 162 are not rotatable about the centerline axis 112. Each fan guide vane 162 has a root and a tip and a span defined therebetween. The fan guide vanes 162 can be unshrouded (as shown in FIG. 1) or can be shrouded, e.g., by an annular shroud spaced outward from the tips of the fan guide vanes 162 along the radial direction R. Each fan guide vane 162 defines a central vane axis 164. For the embodiment of FIG. 1, each fan guide vane 162 of the fan guide vane array 160 is rotatable about their respective central vane axis 164, e.g., in unison with one another. One or more actuators 166 are controlled to pitch the fan guide vanes 162 about their respective central vane axis 164. In other embodiments, each fan guide vane 162 is fixed or is unable to be pitched about the central vane axis 164. The fan guide vanes 162 are mounted to a fan cowl 170.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flowpath, also referred to as a fan duct 172. Incoming air enters through the fan duct 172 through a fan duct inlet 176 and exits through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of struts 174 (only one shown in FIG. 1) that extend substantially radially and are circumferentially spaced about the centerline axis 112. The plurality of struts 174 are each aerodynamically contoured to direct air flowing thereby. Other struts in addition to the plurality of struts 174 can be used to connect and support the fan cowl 170 and/or the core cowl 122.

The gas turbine engine 110 also defines or includes an inlet duct 180. The inlet duct 180 extends between an engine inlet 182 and the core inlet 124 and the fan duct inlet 176. The engine inlet 182 is defined generally at the forward end of the fan cowl 170 and is positioned between the primary fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter 184 of the core cowl 122. The inlet duct 180 is wider than the core duct 142 along the radial direction R. The inlet duct 180 is also wider than the fan duct 172 along the radial direction R.

The fan assembly 150 also includes a mid-fan 186, which includes a plurality of mid-fan blades 188 (only one shown in FIG. 1). The plurality of mid-fan blades 188 are rotatable, e.g., about the centerline axis 112. The mid-fan 186 is drivingly coupled with the LP turbine 134 via the low-speed shaft 138. The plurality of mid-fan blades 188 can be arranged in equal circumferential spacing about the centerline axis 112. The plurality of mid-fan blades 188 are annularly surrounded (e.g., ducted) by the fan cowl 170. In this regard, the mid-fan 186 is positioned inward of the fan cowl 170 along the radial direction R. The mid-fan 186 is positioned within the inlet duct 180 upstream of both the core duct 142 and the fan duct 172. A ratio of a span of a fan blade 154 to that of a mid-fan blade 188 (a span is measured from a root to tip of the respective blade) is greater than two (2) and less than ten (10), to achieve the desired benefits of the third stream (S3), particularly the additional thrust it offers to the engine, which can enable a smaller diameter fan blade 154 (benefits engine installation).

Accordingly, air flowing through the inlet duct 180 flows across the plurality of mid-fan blades 188 and is accelerated downstream thereof. At least a portion of the air accelerated by the mid-fan blades 188 flows into the fan duct 172 and is ultimately exhausted through the fan exhaust nozzle 178 to produce propulsive thrust. Also, at least a portion of the air accelerated by the plurality of mid-fan blades 188 flows into the core duct 142 and is ultimately exhausted through the core exhaust nozzle 140 to produce propulsive thrust. Generally, the mid-fan 186 is a compression device positioned downstream of the engine inlet 182. The mid-fan 186 is operable to accelerate air into the fan duct 172, also referred to as a secondary bypass passage.

During operation of the gas turbine engine 110, an initial or incoming airflow passes through the fan blades 154 of the primary fan 152 and splits into a first airflow and a second airflow. The first airflow bypasses the engine inlet 182 and flows generally along the axial direction A outward of the fan cowl 170 along the radial direction R. The first airflow accelerated by the fan blades 154 passes through the fan guide vanes 162 and continues downstream thereafter to produce a primary propulsion stream or first thrust stream S1. A majority of the net thrust produced by the gas turbine engine 110 is produced by the first thrust stream S1. The second airflow enters the inlet duct 180 through the engine inlet 182.

The second airflow flowing downstream through the inlet duct 180 flows through the plurality of mid-fan blades 188 of the mid-fan 186 and is consequently compressed. The second airflow flowing downstream of the mid-fan blades 188 is split by the splitter 184 located at the forward end of the core cowl 122. Particularly, a portion of the second airflow flowing downstream of the mid-fan 186 flows into the core duct 142 through the core inlet 124. The portion of the second airflow that flows into the core duct 142 is progressively compressed by the LP compressor 126 and the HP compressor 128 and is ultimately discharged into the combustion section. The discharged pressurized air stream flows downstream to the combustor 130 where fuel is introduced to generate combustion gases or products.

The combustor 130 defines an annular combustion chamber that is generally coaxial with the centerline axis 112. The combustor 130 receives pressurized air from the HP compressor 128 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle of the HP turbine 132. The first stage turbine nozzle 133 is defined by an annular flow channel that includes a plurality of radially extending, circumferentially spaced nozzle vanes 135 that turn the combustion gases so that they flow angularly and impinge upon first stage turbine blades of the HP turbine 132. The combustion gases exit the HP turbine 132 and flow through the LP turbine 134 and exit the core duct 142 through the core exhaust nozzle 140 to produce a core air stream, also referred to as a second thrust stream S2. As noted above, the HP turbine 132 drives the HP compressor 128 via the high-speed shaft 136, and the LP turbine 134 drives the LP compressor 126, the primary fan 152, and the mid-fan 186 via the low-speed shaft 138.

The other portion of the second airflow flowing downstream of the mid-fan 186 is split by the splitter 184 into the fan duct 172. The air enters the fan duct 172 through the fan duct inlet 176. The air flows generally along the axial direction A through the fan duct 172 and is ultimately exhausted from the fan duct 172 through the fan exhaust nozzle 178 to produce a third stream, also referred to as a third thrust stream S3.

The third thrust stream S3 is a secondary air stream that increases fluid energy to produce a minority of total propulsion system thrust. In some embodiments, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain embodiments, an operating temperature of the secondary air stream is less than a maximum compressor discharge temperature for the engine. Furthermore in certain embodiments, aspects of the third stream (e.g., airstream properties, mixing properties, or exhaust properties), and thereby a percent contribution to total thrust, are passively adjusted during engine operation or can be modified purposefully through use of engine control features (such as fuel flow, electric machine power, variable stators, variable inlet guide vanes, valves, variable exhaust geometry, or fluidic features) to adjust or to improve overall system performance across a broad range of potential operating conditions.

The gas turbine engine 110 depicted in FIG. 1 is by way of example only. In other embodiments, the gas turbine engine 110 may have any other suitable configuration. For example, in other embodiments, the primary fan 152 may be configured in any other suitable manner (e.g., as a fixed pitch fan) and further may be supported using any other suitable fan frame configuration. In other embodiments, the primary fan 152 can be ducted by a fan casing or a nacelle such that a bypass passage is defined between the fan casing and the fan cowl 170. Moreover, in other embodiments, any other suitable number or configuration of compressors, turbines, shafts, or a combination thereof may be provided. In still other embodiments, aspects of the present disclosure may be incorporated into any other suitable turbine engine, such as, for example, turbofan engines, propfan engines, turbojet engines, turboprop, turboshaft engines, and/or turbine engines defining two streams (e.g., a bypass stream and a core air stream).

Further, for the depicted embodiment of FIG. 1, the gas turbine engine 110 includes an electric machine 190 (motor-generator) operably coupled with a rotating component thereof. In this regard, the gas turbine engine 110 is a hybrid-electric propulsion machine. Particularly, as shown in FIG. 1, the electric machine 190 is operatively coupled with the LP shaft 138. The electric machine 190 can be mechanically connected to the LP shaft 138, either directly, or indirectly, e.g., by way of a gearbox assembly 192 (shown schematically in FIG. 1). Further, although in this embodiment the electric machine 190 is operatively coupled with the LP shaft 138 at an aft end of the LP shaft 138, the electric machine 190 can be coupled with the LP shaft 138 at any suitable location or can be coupled to other rotating components of the gas turbine engine 110, such as the HP shaft 136 or the LP shaft 138. For instance, in some embodiments, the electric machine 190 can be coupled with the LP shaft 138 and positioned forward of the mid-fan 186 along the axial direction A. In some embodiments, the turbine engine 110 of FIG. 1 also includes an electric machine coupled to the LP shaft 138 and located in the tail cone of the turbine engine 110.

In some embodiments, the electric machine 190 can be an electric motor operable to drive or motor the low-speed shaft 138, e.g., during an engine burst. In other embodiments, the electric machine 190 can be an electric generator operable to convert mechanical energy into electrical energy. In this way, electrical power generated by the electric machine 190 can be directed to various engine and/or aircraft systems of the turbine engine 110. In some embodiments, the electric machine 190 can be a motor/generator with dual functionality. The electric machine 190 includes a rotor 194 and a stator 196. The rotor 194 is coupled to the low-speed shaft 138 and rotates with rotation of the low-speed shaft 138. In this way, the rotor 194 rotates with respect to the stator 196, thereby generating electrical power. Although the electric machine 190 has been described and illustrated in FIG. 1 as having a particular configuration, the present disclosure may apply to electric machines having alternative configurations. For instance, the rotor 194 and/or the stator 196 may have different configurations or may be arranged in a different manner than illustrated in FIG. 1.

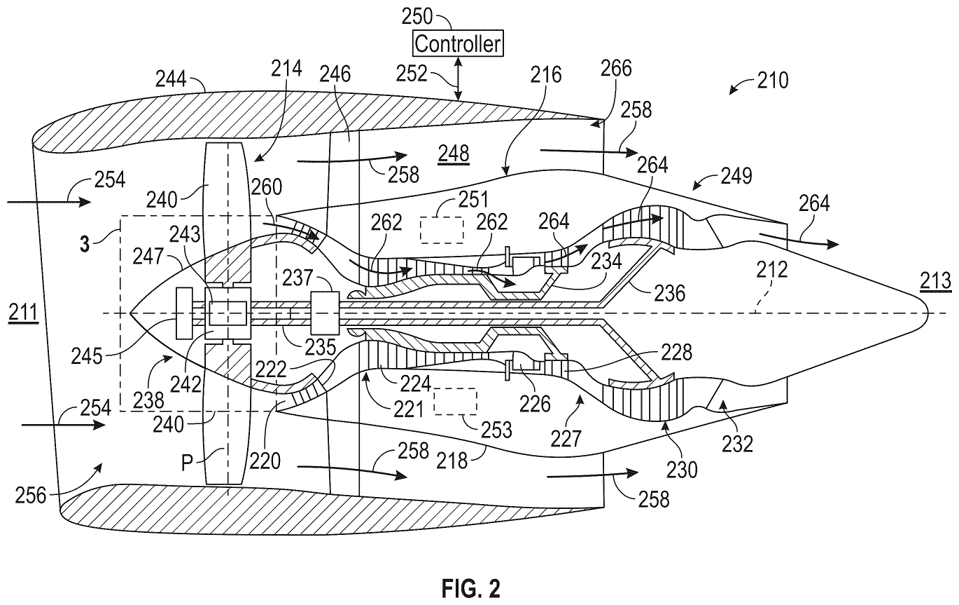

FIG. 2 is a schematic, cross-sectional diagram of an exemplary turbine engine 210, taken along a longitudinal centerline axis 212 of the turbine engine 210, as may incorporate various embodiments of the present disclosure. In particular, in the illustrated embodiment, the turbine engine 210 is a ducted, high by-pass turbofan jet engine. As shown in FIG. 2, the longitudinal centerline axis 212 extends through the turbine engine 210 from an upstream end 211 to a downstream end 213 of the turbine engine 210, for reference purposes. In general, the turbine engine 210 includes a fan section 214 and a turbo-engine 216 disposed downstream from the fan section 214.

The turbo-engine 216 may generally include an outer casing 218 that defines an annular inlet 220 to the turbo-engine 216. The outer casing 218 encases, or at least partially forms, the turbo-engine 216. The turbo-engine 216 includes, in a serial flow relationship, a compressor section 221 that includes a booster or a low-pressure (LP) compressor 222 and a high-pressure (HP) compressor 224, a combustor 226, a turbine section 227 that includes a high-pressure (HP) turbine 228 and a low-pressure (LP) turbine 230, and a jet exhaust nozzle 232. A high-pressure (HP) shaft 234 drivingly connects the HP turbine 228 to the HP compressor 224. A low-pressure (LP) shaft 236 drivingly connects the LP turbine 230 to the LP compressor 222. The LP shaft 236 may also be connected to a gearbox assembly 237, such as in an indirect-drive or a geared-drive configuration. In other embodiments, although not illustrated, the turbine engine 210 may further include an intermediate-pressure compressor and an intermediate-pressure turbine rotatable with an intermediate-pressure shaft that connects the intermediate-pressure turbine and the intermediate-pressure compressor.

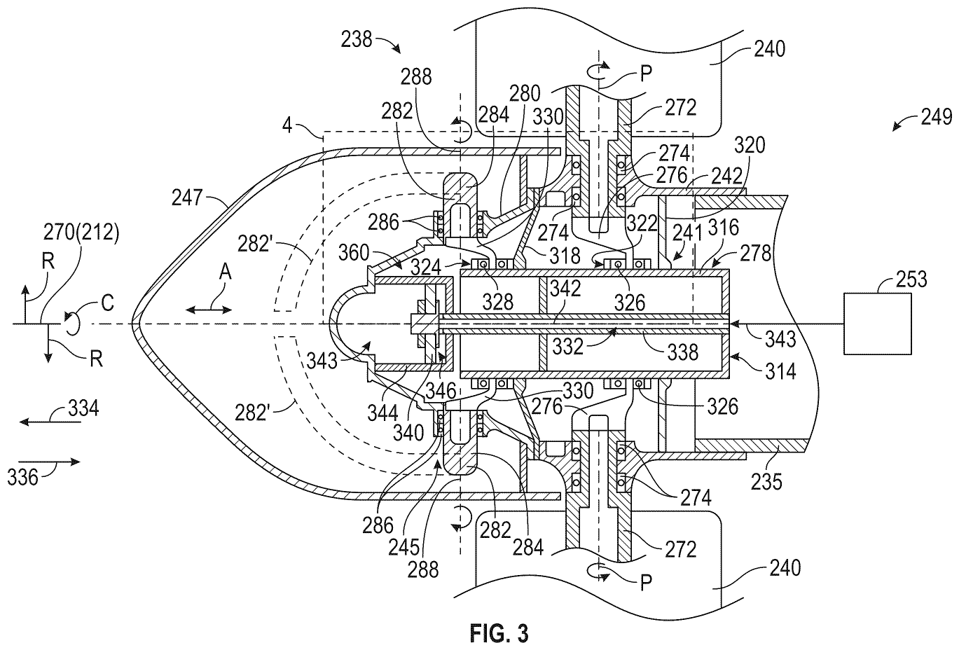

For the embodiment depicted in FIG. 2, the fan section 214 includes a fan assembly 238 (e.g., a variable pitch fan) having a plurality of fan blades 240 (two are shown in FIG. 2) rotationally coupled to a fan blade hub 242 in a circumferentially spaced-apart manner. As depicted in FIG. 2, the plurality of fan blades 240 extends outwardly from the fan blade hub 242 generally along a radial direction R (FIG. 3). Each fan blade 240 is rotatable relative to the fan blade hub 242 about a blade pitch change axis P by virtue of the plurality of fan blades 240 being operatively coupled to a fan actuation system 241 (shown in FIG. 3) that includes an actuator 243 (described in more detail below) configured to collectively vary the pitch angle of the fan blades 240 in unison, and a counterweight system 245, which will be described in more detail below. The fan assembly 238 also includes a spinner fairing 247 that surrounds the fan actuation system 241 and the counterweight system 245.

In the illustrated embodiment, and, as described in more detail below, a lubrication system 249 of the turbine engine 210 includes a gearbox lubrication system 251 and a fan actuation system (FAS) lubrication system 253 (both depicted as dashed boxes in FIG. 2). As the gearbox assembly 237 operates, the gearbox lubrication system 251 supplies a hydraulic fluid (e.g., oil) to the gearbox assembly 237 through one or more gearbox lubricant supply lines (not shown). The FAS lubrication system 253 includes one or more FAS lubricant supply lines (not shown) for supplying a hydraulic fluid (e.g., oil) to the fan actuation system 241.

The plurality of fan blades 240, the fan blade hub 242, the counterweight system 245, the spinner fairing 247, and the actuator 243 are together rotatable about the longitudinal centerline axis 212 via a fan shaft 235 that is powered by the LP shaft 236 across the gearbox assembly 237. The gearbox assembly 237 includes a plurality of gears (not shown) for adjusting the rotational speed of the fan shaft 235 and for adjusting the rotational speed of the fan assembly 238 relative to the LP shaft 236.

In the embodiment of FIG. 2, an annular fan casing or a nacelle 244 circumferentially surrounds the fan section 214 and at least a portion of the turbo-engine 216 of the turbine engine 210. Thus, the embodiment of FIG. 2 depicts a ducted fan type turbine engine. In other embodiments, however, such as in an unducted fan type turbine engine, the nacelle 244 and associated supporting structure (described below), would be omitted. The nacelle 244 may be supported relative to the turbo-engine 216 by a plurality of circumferentially spaced outlet guide vanes or struts 246. Moreover, at least a portion of the nacelle 244 may extend over an outer portion of the turbo-engine 216 so as to define a bypass airflow passage 248 between the nacelle 244 and the outer casing 218.

An engine controller 250 electrically communicates with various components of the turbine engine 210 via a communication channel 252. The engine controller 250 may be a full authority digital engine controller (FADEC) that controls operation of the turbine engine 210 via control signals transmitted to the various components of the turbine engine 210 via the communication channel 252, and by receiving signals from the various components of the turbine engine 210 via the communication channel 252. The engine controller 250 may be provided within the turbine engine 210, or within a structure to which the turbine engine 210 is mounted (e.g., an aircraft).

During a standard operating mode of the turbine engine 210, a volume of air 254 enters the turbine engine 210 through an inlet 256 of the nacelle 244, the fan section 214, or both. As the volume of air 254 passes across the fan blades 240, a first portion of air 254, shown as bypass air 258, is directed or routed into the bypass airflow passage 248, and a second portion of the volume of air 254, shown as core air 260, is directed or is routed into the annular inlet 220 of the LP compressor 222. The bypass air 258 is routed through the bypass airflow passage 248 before being exhausted from a fan bypass nozzle 266 of the turbine engine 210, providing the main propulsive thrust for the turbine engine 210. A ratio between the bypass air 258 and the core air 260 is known as a bypass ratio. The core air 260 is compressed by the LP compressor 222, generating compressed air 262, and the compressed air 262 is routed through the HP compressor 224, where the compressed air 262 is further compressed before being directed into the combustor 226.

In the combustor 226, the compressed air 262 is mixed with fuel and burned to generate combustion gases 264 (also referred to as combustion products). The combustion gases 264 are routed from the combustor 226 into the HP turbine 228 and expanded through the HP turbine 228. In the HP turbine 228, a portion of thermal energy and/or kinetic energy from the combustion gases 264 is extracted by the HP turbine 228, causing the HP shaft 234 to rotate, supporting operation of the HP compressor 224. The combustion gases 264 are then routed into the LP turbine 230 and are further expanded through the LP turbine 230. Here, a second portion of the thermal energy and the kinetic energy is extracted from the combustion gases 264, causing the LP shaft 236 to rotate, supporting operation of the LP compressor 222 and rotation of the fan assembly 238 via the gearbox assembly 237. The combustion gases 264 are subsequently routed through the jet exhaust nozzle 232 of the turbo-engine 216 to provide additional propulsive thrust.

FIG. 3 is an enlarged, detailed, cross-sectional view of the fan assembly 238, taken at detail “3” of FIG. 2, according to an aspect of the present disclosure. As shown in FIG. 3, the fan assembly 238 defines a fan assembly centerline axis 270, which may be congruent with the longitudinal centerline axis 212 of the turbine engine 210. The fan blade hub 242 is connected to the fan shaft 235, and the fan shaft 235 drives rotation of the fan assembly 238 about the fan assembly centerline axis 270.

As was described above, the fan assembly 238 includes the plurality of fan blades 240, and the fan blades 240 are rotationally connected to the fan blade hub 242 to rotate about their respective blade pitch change axis P. For example, each of the fan blades 240 may include a fan blade trunnion 272 that is connected to the fan blade hub 242 via one or more fan blade trunnion bearings 274, and a blade crank arm 276 is attached to the fan blade trunnion 272. As will be described below, the blade crank arm 276 is driven by an actuator assembly 278 (corresponding to the actuator 243 of FIG. 2) that translates in an axial direction A to cause rotation of each fan blade trunnion 272 about their respective blade pitch change axis P so as to rotate the respective fan blade 240. The fan blade trunnion bearings 274 may be any type of bearing (e.g., tapered roller bearings, spherical roller bearings, cylindrical roller bearings, needle roller bearings, thrust ball bearings, angular contact roller bearings, deep groove ball bearings, etc.), and are not limited to any particular type of bearing.

As described above, the fan assembly 238 includes the counterweight system 245 that is arranged remotely from the plurality of fan blades 240. That is, the counterweight system 245 is not connected to the plurality of fan blades 240 directly. For example, the counterweight system 245 is not connected to any part of each of the fan blades 240, including the plurality of fan blade trunnions 272 connecting the plurality of fan blades 240 to the fan blade hub 242. Similarly, the counterweight system 245 is not connected to the fan blades 240 via a linkage that may, for example, connect the fan blades 240 to a counterweight that may, for example, be attached to the fan blade hub 242. Rather, the counterweight system 245 is located apart from the plurality of fan blades 240, and is arranged to impart counteracting axial loads to an actuator that drives rotation of the plurality of fan blades 240, and that also drives rotation of the counterweight system 245.

In FIG. 3, the counterweight system 245 includes a counterweight hub 280 that may be connected to the fan blade hub 242, such that rotation of the fan blade hub 242 about the fan assembly centerline axis 270 when the fan blade hub 242 is driven by the fan shaft 235, drives rotation of the counterweight hub 280 about the fan assembly centerline axis 270. The counterweight hub 280 has a plurality of counterweight levers 282 that are rotationally connected to the counterweight hub 280. For example, each of the counterweight levers 282 may be mounted to the counterweight hub 280 via one or more counterweight trunnion bearings 286 that provide the ability for the counterweight lever 282 to rotate about a counterweight lever rotational axis 288.

As shown in FIG. 3, the counterweight system 245 includes the plurality of counterweight levers 282, and each counterweight lever 282 includes a counterweight trunnion portion 284 that is rotationally connected to the counterweight hub 280 via the counterweight trunnion bearings 286. The counterweight trunnion bearings 286 may be any type of bearing (e.g., tapered roller bearings, spherical roller bearings, cylindrical roller bearings, needle roller bearings, thrust ball bearings, angular contact roller bearings, deep groove ball bearings, etc.), and are not limited to any particular type of bearing. The counterweight trunnion portion 284 is rotational about the counterweight lever rotational axis 288 that extends through the counterweight trunnion portion 284 and extends radially from the fan assembly centerline axis 270 (i.e., in the radial direction R).

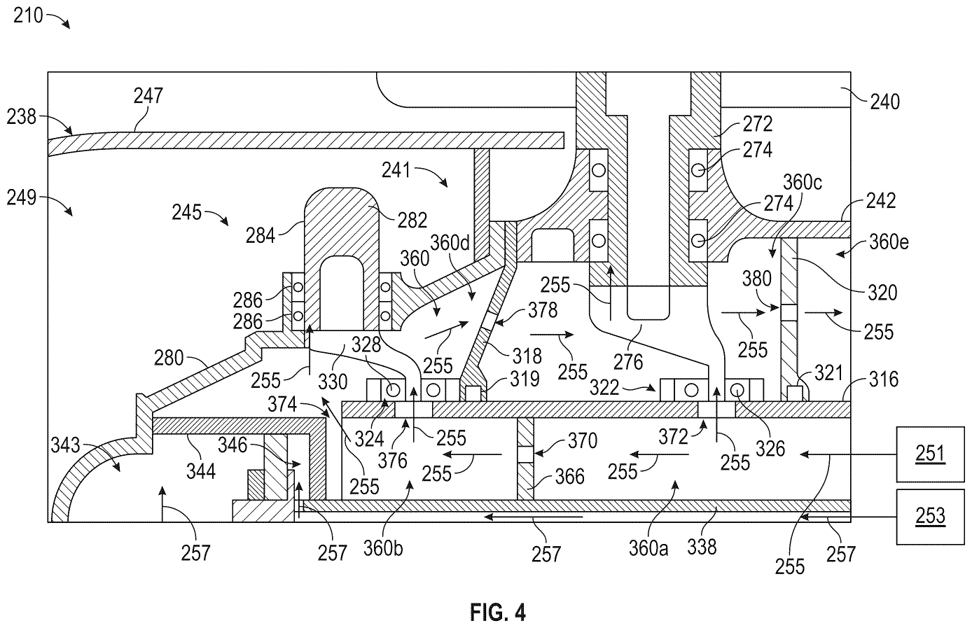

Referring still to FIG. 3, the actuator assembly 278 includes a shaft assembly 314 having an actuator shaft 316. The actuator shaft 316 may be supported by a forward shaft support 318 and by an aft shaft support 320, each of which may be fixedly connected with the fan blade hub 242. The forward shaft support 318 and the aft shaft support 320 slidingly engage with the actuator shaft 316 to allow axial translation of the actuator shaft 316 in the axial direction A, but to limit radial movement of actuator shaft 316 in the radial direction R with respect to the fan assembly centerline axis 270. In the illustrated embodiment, the forward shaft support 318 includes a forward sliding member 319 (FIG. 4) and the aft shaft support 320 includes an aft sliding member 321 (FIG. 4). The forward sliding member 319 and the aft sliding member 321 slidingly engage an outer surface of the actuator shaft 316 as the actuator shaft 316 translates axially relative to the forward shaft support 318 and the aft shaft support 320.

The actuator shaft 316 includes a fan blade engagement portion 322 that is arranged to drive rotation of each of the plurality of fan blades 240 about the respective blade pitch change axis P. More particularly, for each fan blade 240, a fan blade shaft bearing member 326 may be implemented within the fan blade engagement portion 322 and the blade crank arm 276 of each fan blade 240 may be engaged with the fan blade shaft bearing member 326, such that axial translation of the actuator shaft 316 along the fan assembly centerline axis 270 drives the blade crank arm 276 and the fan blade trunnion 272 about the blade pitch change axis P so as to rotate the fan blade 240 about the blade pitch change axis P.

In addition, the actuator shaft 316 includes a counterweight engagement portion 324 that is arranged to drive rotation of each of the plurality of counterweight levers 282 about the respective counterweight lever rotational axis 288. More particularly, for each counterweight lever 282, a counterweight shaft bearing member 328 may be implemented within the counterweight engagement portion 324 and a lever crank arm 330, which is connected to the counterweight trunnion portion 284, may be engaged with the counterweight shaft bearing member 328, such that axial translation of the actuator shaft 316 along the fan assembly centerline axis 270 drives the lever crank arm 330 and the counterweight trunnion portion 284 about the respective counterweight lever rotational axis 288 so as to rotate the counterweight lever 282. In FIG. 3, a ninety-degree (90°) rotated position of the counterweight levers 282 is shown in dashed lines as counterweight levers 282′ for reference purposes.

With continued reference to FIG. 3, to drive the actuator shaft 316 in the axial direction A along the fan assembly centerline axis 270, the shaft assembly 314 includes a hydraulic drive portion 332 arranged to drive axial movement of the actuator shaft 316 in a forward direction 334 along the fan assembly centerline axis 270, and in an aft direction 336 along the fan assembly centerline axis 270. The hydraulic drive portion 332 may include a piston rod 338 that is fixedly connected to the actuator shaft 316, and is also connected to a piston head 340. The piston head 340 is arranged to slidingly engage with a piston housing 344 so that the piston head 340 can translate in the axial direction A within the piston housing 344. The piston rod 338 includes one or more hydraulic fluid passages 342 therewithin, and a flow of an actuation fluid 257 (e.g., oil) can flow therethrough into a forward piston cavity 343 and an aft piston cavity 346. Particularly, the actuation fluid 257 is driven by the FAS lubrication system 253 to flow into and out of the hydraulic fluid passage 342 and into and out of one or both of the forward piston cavity 343 or the aft piston cavity 346, so as to drive the piston head 340 and the actuator shaft 316 in one of the forward direction 334 or the aft direction 336.

Flow of the actuation fluid 257 to the piston housing 344 via the FAS lubrication system 253 is controlled, for example, by the engine controller 250. Particularly, the engine controller 250 is configured to control flow of the actuation fluid 257 based on command signals to change the pitch angle of the fan blades 240 (i.e., to either increase the pitch angle of the fan blades 240 or to decrease the pitch angle of the fan blades 240). Thus, the actuator assembly 278 is actuated to provide axial movement of the actuator shaft 316 in the forward direction 334 and in the aft direction 336, causing rotation of each of the fan blades 240 about their respective pitch change axis P to change the pitch angle of each fan blade 240, and, at the same time, the actuator shaft 316 drives rotation of each of the counterweight levers 282 about their respective counterweight lever rotational axis 288.

FIG. 4 is an enlarged, detailed, cross-sectional view of the fan assembly 238, taken at detail “4” of FIG. 3, according to an aspect of the present disclosure. As shown in FIG. 4, a first or a forward sump cavity 360 is defined by the fan section 214 of the turbine engine 210. Particularly, the forward sump cavity 360 is at least partially defined by each of the fan blade hub 242, the counterweight hub 280, and the actuator shaft 316. As such, during operation of the turbine engine 210, the forward sump cavity 360 rotates about the fan assembly centerline axis 270 (FIG. 2) with the fan blade hub 242, the counterweight hub 280, and the actuator shaft 316.

In addition to the forward sump cavity 360, the turbine engine 210 may include one or more other sumps enclosing various bearings, seals, and drives of the fan section 214 or the turbo-engine 216 (FIG. 2) to contain lubrication fluid provided thereto. In the illustrated embodiment, contained within the forward sump cavity 360 are the blade crank arm 276 and the fan blade engagement portion 322 of each of the plurality of fan blades 240 of the fan actuation system 241 as well as the counterweight engagement portion 324, the counterweight shaft bearing member 328, and the lever crank arm 330 of each of the plurality of counterweight levers 282 of the counterweight system 245.

In the illustrated embodiment, inner ends of the fan blade trunnions 272 of the fan actuation system 241 are in fluid communication with the forward sump cavity 360. For example, each of the plurality of fan blade trunnions 272 can include a sealing member (not shown) along an outer diameter of the fan blade trunnion 272 that forms a seal between the fan blade trunnion 272 and the fan blade hub 242, while an inner diameter thereof is in fluid communication with the forward sump cavity 360. Likewise, inner ends of the plurality of counterweight trunnion portions 284 of the counterweight system 245 are in fluid communication with the forward sump cavity 360. For example, each of the counterweight trunnion portions 284 can include a sealing member (not shown) along an outer diameter of the counterweight trunnion portion 284 that forms a seal between the counterweight trunnion portion 284 and the counterweight hub 280, while an inner diameter thereof is in fluid communication with the forward sump cavity 360. Not requiring seals on the inner ends of the plurality of fan blade trunnions 272 and the plurality of counterweight trunnion portions 284 can reduce a radius ratio, while still lubricating the fan blade trunnion bearings 274, the counterweight trunnion bearings 286, the fan blade shaft bearing members 326, and the counterweight shaft bearing members 328.

Flow of a lubrication fluid 255 (e.g., oil) is supplied to the forward sump cavity 360 by the gearbox lubrication system 251 of the turbine engine 210 (FIG. 2) via one or more gearbox lubricant supply lines (not shown). Particularly, in the illustrated embodiment, the lubrication fluid 255 flows from the gearbox assembly 237 (FIG. 2) and into the forward sump cavity 360 at a first void area 360a defined between the actuator shaft 316 and the piston rod 338. In other words, flow of the lubrication fluid 255 is provided along the fan assembly centerline axis 270 (FIG. 3), which may be congruent with the longitudinal centerline axis 212 of the turbine engine 210. In some embodiments, the lubrication fluid 255 can be provided to the forward sump cavity 360 at one or more locations in addition to, or alternative to, the first void area 360a. In some embodiments, flow of the lubrication fluid 255 from the gearbox lubrication system 251 can first flow through the gearbox assembly 237 (FIG. 2) and then to the forward sump cavity 360. In some embodiments, a portion of the flow of the actuation fluid 257 (FIG. 2) supplied by the FAS lubrication system 253 can be provided to the forward sump cavity 360, in addition to or alternative to, the flow of the lubrication fluid 255 from the gearbox lubrication system 251.

With the forward sump cavity 360 rotating about the fan assembly centerline axis 270 (FIG. 3) during operation of the turbine engine 210, centrifugal forces cause the lubrication fluid 255 to flow through the forward sump cavity 360, as represented schematically by arrows in FIG. 4. As shown in FIG. 4, a portion of the lubrication fluid 255 within the first void area 360a flows to a second void area 360b of the forward sump cavity 360, while another portion of the lubrication fluid 255 within the first void area 360a flows through the fan blade engagement portions 322 (FIG. 3) of the fan actuation system 241 to a third void area 360c. The second void area 360b of the forward sump cavity 360 is defined between the actuator shaft 316 and the piston rod 338. In the illustrated embodiment, the second void area 360b is separated from the first void area 360a by a piston rod support 366. The lubrication fluid 255 can flow from the first void area 360a to the second void area 360b, e.g., via a first passage 370 defined in the piston rod support 366. The third void area 360c of the forward sump cavity 360 is defined by the fan blade hub 242, the actuator shaft 316, the forward shaft support 318, and the aft shaft support 320. The lubrication fluid 255 can flow from the first void area 360a to the third void area 360c, e.g., via a second passage 372 defined in the actuator shaft 316. In the illustrated embodiment, the second passage 372 is disposed adjacent to the fan blade engagement portions 322 of the counterweight system 245 such that the lubrication fluid 255 flows through the fan blade engagement portions 322. In some embodiments, the piston rod support 366 may not be included (and thus also the first passage 370 may not be included) such that the first void area 360a and the second void area 360b are one in the same.

A portion of the lubrication fluid 255 within the second void area 360b flows directly into a fourth void area 360d of the forward sump cavity 360 adjacent to the piston housing 344, while another portion of the lubrication fluid 255 within the second void area 360b flows through the counterweight shaft bearing member 328 of the counterweight system 245 and into the fourth void area 360d. The fourth void area 360d of the forward sump cavity 360 is defined by the counterweight hub 280, the actuator shaft 316, and the forward shaft support 318. A gap 374 between the actuator shaft 316 and the piston housing 344 can permit the lubrication fluid 255 to flow out of the second void area 360b and directly into the fourth void area 360d. The lubrication fluid 255 can flow from the second void area 360b and through the counterweight engagement portion 324 to the fourth void area 360d, e.g., via a third passage 376 defined in the actuator shaft 316.

As mentioned above, inner ends of the counterweight trunnion portion 284 of the counterweight system 245 are in fluid communication with the forward sump cavity 360, particularly, the fourth void area 360d thereof. As such, during operation of the turbine engine 210, the lubrication fluid 255 flowing through the fourth void area 360d flows into the counterweight trunnion portions 284. Thus, the lubrication fluid 255 is able to flood the counterweight trunnion portions 284 and lubricate the one or more counterweight trunnion bearings 286 of the counterweight system 245.

From the fourth void area 360d, the lubrication fluid 255 flows into the third void area 360c, e.g., via a fourth passage 378 defined in the forward shaft support 318. As mentioned above, inner ends of the plurality of fan blade trunnions 272 of the fan actuation system 241 are in fluid communication with the forward sump cavity 360, particularly, the third void area 360c thereof. As such, during operation of the turbine engine 210, a portion of the lubrication fluid 255 flowing through the third void area 360c flows into the plurality of fan blade trunnions 272. Thus, the lubrication fluid 255 is able to flood the plurality of fan blade trunnions 272 and lubricate the one or more fan blade trunnion bearings 274 of the fan actuation system 241, as active flow of the lubrication fluid 255 from the gearbox lubrication system 251 is not needed for actuation of the fan actuation system 241.

The lubrication fluid 255 within the third void area 360c flows into a fifth void area 360e of the forward sump cavity 360, e.g., via a fifth passage 380 defined in the aft shaft support 320. The fifth void area 360e is at least partially defined by the fan blade hub 242, the actuator shaft 316, and the aft shaft support 320. From the fifth void area 360e, the lubrication fluid 255 can flow to one or more bearings (not shown) contained within the forward sump cavity 360 to lubricate the one or more bearings. In other words, a flow path of at least a portion of the lubrication fluid 255 first extends through the forward sump cavity 360 in the forward direction 334 (FIG. 3), i.e., through the first void area 360a to the second void area 360b, and then in the aft direction 336 (FIG. 3), i.e., through the fourth void area 360d to the third void area 360c and then to the fifth void area 360e. Flow of the lubrication fluid 255 through the forward sump cavity 360, particularly, the third void area 360c and the fourth void area 360d thereof, can also provide lubrication to the forward sliding member 319 and the aft sliding member 321.

In some embodiments, the fan assembly 238 of the turbine engine 210 may not include the counterweight system 245, and thus some components and some structural elements of the fan assembly 238 may differ from the fan assembly 238 illustrated in FIGS. 2 to 4. As such, in some such embodiments, a flow path of lubrication fluid through the forward sump cavity 360 may differ than the flow of the lubrication fluid 255 illustrated in FIG. 4. For example, in some such embodiments, the fan assembly 238 may not include the counterweight hub 280 such that the piston housing 344 is mounted to the fan blade hub 242 and the forward sump cavity 360 is defined by the fan blade hub 242 and the piston rod 338.

In some embodiments, the fan assembly 238 may be configured such that flow of the lubrication fluid 255 through the forward sump cavity 360 lubricates components only of the fan actuation system 241, and not components of the counterweight system 245. For example, in some such embodiments, the lubrication fluid 255 may flow from the first void area 360a, to the third void area 360c, and then to the fifth void area 360e, thus, bypassing the second void area 360b and the third void area 360c. In some such embodiments, the counterweight system 245 may utilize different lubrication means, e.g., sealed localized grease packs.

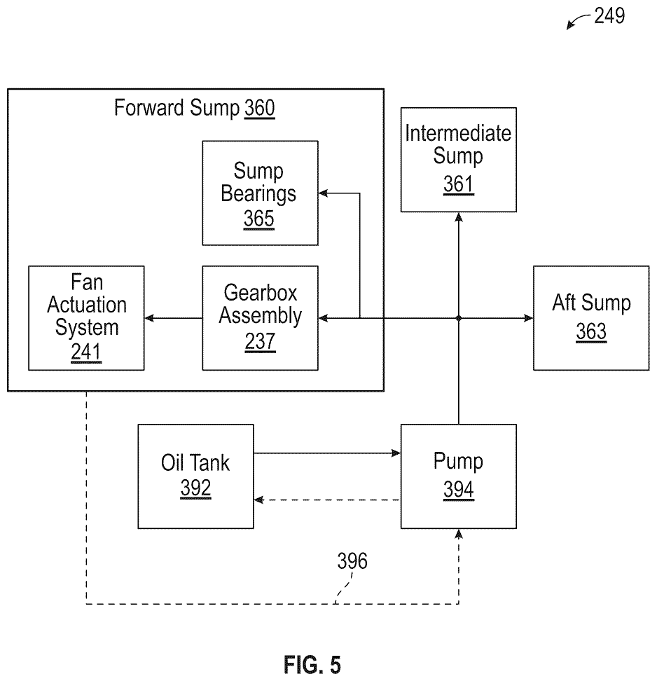

FIG. 5 is a schematic representation of the lubrication system 249 of the turbine engine 210, according to the present disclosure. As mentioned above, in addition to the forward sump cavity 360 (FIG. 4), the turbine engine 210 may include one or more other sumps enclosing various bearings, seals, and drives of the fan section 214 and of the turbo-engine 216 (FIG. 2) via various sump seals, to contain lubrication fluid provided thereto. In the illustrated embodiment of FIG. 5, the turbine engine 210 includes one or more forward sumps (e.g., the forward sump cavity 360 (FIG. 4)), one or more intermediate sumps 361 located aft of the forward sump cavity 360, and one or more aft sumps 363 located aft of the one or more intermediate sumps 361. The one or more forward sumps (e.g., the forward sump cavity 360 (FIG. 4)) is defined by the fan section 214, the one or more intermediate sumps 361 is defined by at least one of the fan section 214 or the turbo-engine 216, and the one or more aft sumps 363 is defined by the turbo-engine 216.

The lubrication system 249 includes an oil tank 392 and a pump 394. The pump 394 pumps lubrication fluid (e.g., the lubrication fluid 255) from the oil tank 392 to each of the one or more forward sumps (e.g., the forward sump cavity 360 (FIG. 4)), the one or more intermediate sumps 361, and the one or more aft sumps 363. Particularly, in the illustrated embodiment, the pump 394 provides lubrication fluid to the gearbox assembly 237. In this way, the gearbox lubrication system 251 (FIG. 4) is part of the lubrication system 249 of the turbine engine 210. From the gearbox assembly 237, a first portion of lubrication fluid flows to the fan actuation system 241, while a second portion of lubrication fluid can flow to one or more sump bearings 365 disposed within the forward sump cavity 360. In some embodiments, lubrication fluid provided to the fan actuation system 241 by the pump 394 may bypass the gearbox assembly 237.

During operation of the turbine engine, the lubrication fluid 255 actively circulates through the forward sump cavity 360. Particularly, the lubrication fluid 255 drains out of the forward sump cavity 360 and back to the oil tank 392 via a forward sump scavenge line 396 that provides fluid communication between the forward sump cavity 360 and the pump 394. Further, once operation of the turbine engine 210 is ceased (i.e., the fan assembly 238 no longer rotates about the fan assembly centerline axis 270), the lubrication fluid 255 drains from the plurality of fan blade trunnions 272 and the plurality of counterweight trunnion portions 284 into the forward sump cavity and back to the oil tank 392 via the forward sump scavenge line 396.

In some embodiments, the gearbox lubrication system 251 (FIG. 4) may be a separate, distinct system from the lubrication system 249. For example, in some such embodiments, the gearbox lubrication system 251 (FIG. 4) may include a second oil tank and a second pump that are different than the oil tank 392 and the pump 394 of the lubrication system 249. In some embodiments, lubrication fluid from the oil tank 392 may be provided to the FAS lubrication system 253 (FIG. 2). In some embodiments, the lubrication system 255 can be tapped from a main oil circuit (not shown) of the turbine engine 210.

The plurality of fan blades 240, the plurality of counterweight levers 282, and the counterweight hub 280 reject heat to the flow path of the lubrication fluid 255 through the forward sump cavity 360 and under the spinner fairing 247. However, the lubrication fluid 255 circulating through the lubrication system 249 may increase in temperature as the lubrication fluid 255 interacts with various rotating components of the turbine engine 210. In this way, the lubrication fluid 255 flowing through the forward sump cavity 360 may have a higher temperature and, thus, be less viscous, as compared to closed circuit lubrication systems or conventional grease pack lubrication configurations. The less viscous lubrication fluid 255 within the forward sump cavity 360 can further reduce friction among the various rotating components of the fan section 214 at altitude. Further, the warmed lubrication fluid 255 flowing through the forward sump cavity 360 may also warm the actuation fluid 257 contained within the piston housing 344. This can improve actuation of the piston head 340.

In addition to lubricating the components of the fan actuation system 241 and the counterweight system 245, flow of the lubrication fluid 255 through the forward sump cavity 360 may also function to remove heat from the lubrication fluid 255 that is circulated through the lubrication system 249 during continued operation of the turbine engine 210. In particular, the forward sump cavity 360 is disposed within the spinner fairing 247 (FIG. 3) of the turbine engine 210, which is exposed to ambient air. Thus, the lubrication fluid 255 flowing through the forward sump cavity 360, particularly, through the fourth void area 360d thereof, may be cooled by the counterweight hub 280. As such, in some embodiments, the flow of the lubrication fluid 255 through the forward sump cavity 360 can be increased in order to reject more heat from the lubrication system 249.

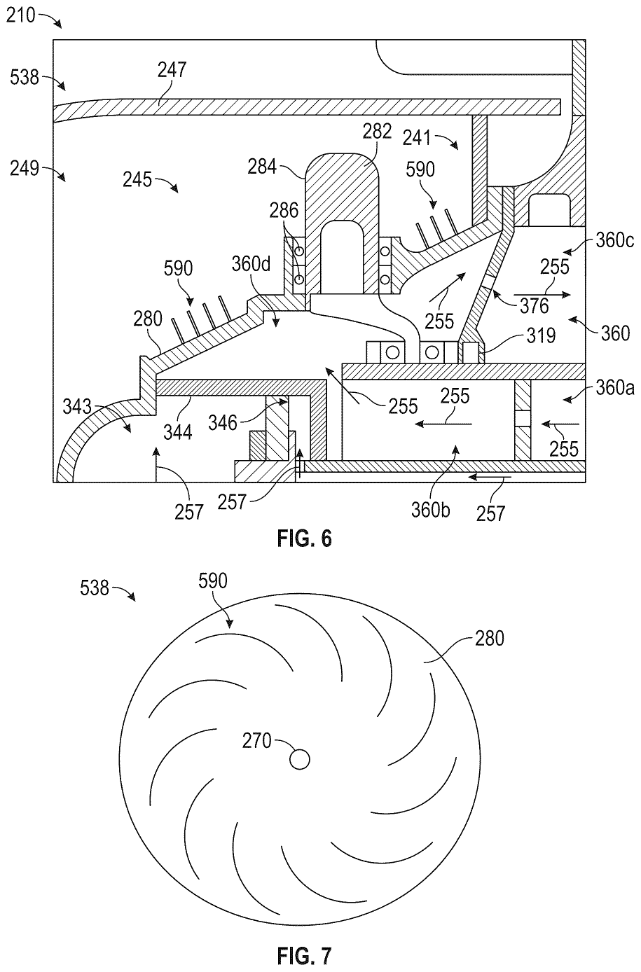

In some embodiments, the fan assembly 238 may be configured to further increase removal of heat from the lubrication fluid 255 of the lubrication system 249 as the lubrication fluid 255 flows through the forward sump cavity 360. For example, FIG. 6 is an enlarged, detailed, cross-sectional view of an exemplary fan assembly 538 of the turbine engine 210 of FIG. 2, taken along the longitudinal centerline axis 212 of the turbine engine 210, according to another embodiment of the present disclosure. The fan assembly 538 is substantially similar to the fan assembly 238 of FIGS. 2 to 4. The same reference numerals or similar reference numerals will be used for components of the fan assembly 538 that are the same as, or similar to, the components of the fan assembly 238 discussed above with regard to FIGS. 2 to 4. The description of such components of the fan assembly 238 above also applies to these components of the fan assembly 538, and a detailed description of these components is omitted here.

As shown in FIG. 6, in the illustrated embodiment, the fan assembly 538 includes a plurality of fins 590 extending radially outward from the counterweight hub 280 of the counterweight system 245. More specifically, the plurality of fins 590 is disposed along an outermost surface of the counterweight hub 280 adjacent to the fourth void area 360d of the forward sump cavity 360. The plurality of fins 590 can provide an increased surface area of the counterweight hub 280 to interact with ambient air and, thus, can decrease a temperature of the counterweight hub 280. This can further increase removal of heat from the lubrication fluid 255 as the lubrication fluid 255 flows through the fourth void area 360d. In some embodiments, the plurality of fins 590 may instead be a plurality of channels that is defined by an outermost surface of the counterweight hub 280.

In some embodiments, the plurality of fins 590 may be shaped to further increase the surface area of the counterweight hub 280. For example, FIG. 7 is a schematic, aft-looking view of the plurality of fins 590 of the fan assembly 538 of FIG. 6. As shown in FIG. 7, the plurality of fins 590 may be curved as the fins 590 extend radially outward from the fan assembly centerline axis 270 (i.e., “swept”) such that, as the fan assembly 538 rotates about the fan assembly centerline axis 270, ambient air flows through the plurality of fins 590 and interacts with a larger surface area of the counterweight hub 280 as compared to fins that extend straight radially outward.

In some embodiments, the counterweight hub 280 may be formed of a first material and the plurality of fins 590 may be formed of a second material having one or more properties that differ from those of the first material. In some embodiments, at least one fin of the plurality of fins 590 may be formed of a first material while the other fins of the plurality of fins 590 may be formed of a second material having one or more properties that differ from those of the first material.

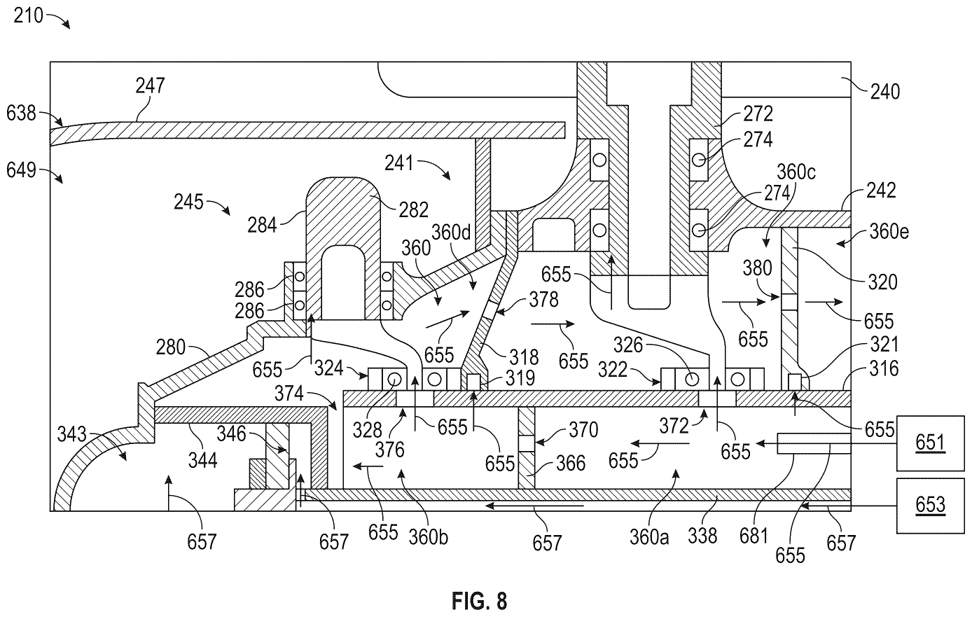

FIG. 8 is an enlarged, detailed, cross-sectional view of an exemplary fan assembly 638 and a lubrication system 649 of the turbine engine 210 of FIG. 2, taken along the longitudinal centerline axis 212 of the turbine engine 210, according to another embodiment of the present disclosure. The fan assembly 638 and the lubrication system 649 are substantially similar to the fan assembly 238 of FIGS. 2 to 4 and the lubrication system 249 of FIG. 5. The same reference numerals or similar reference numerals will be used for components of the fan assembly 638 and the lubrication system 649 that are the same as, or similar to, the components of the fan assembly 238 and the lubrication system 249 discussed above with regard to FIGS. 2 to 5. The description of such components of the fan assembly 238 and the lubrication system 249 above also applies to these components of the fan assembly 638 and the lubrication system 649, and a detailed description of these components is omitted here.

As shown in FIG. 8, in the illustrated embodiment, the lubrication system 649 includes a gearbox lubrication system 651 that provides a lubrication fluid 655 (e.g., oil) to the forward sump cavity 360 of the fan assembly 638 and a fan actuation system (FAS) lubrication system 653 that provides an actuation fluid 657 (e.g., oil) to the piston housing 344. Particularly, in the illustrated embodiment, the lubrication fluid 655 from the gearbox lubrication system 651 flows from the gearbox assembly 237 (FIG. 2) and into the forward sump cavity 360 via a nozzle 681 disposed within the first void area 360a. The fan assembly 638 and the lubrication system 649 are configured such that the lubrication fluid 655, as provided by the nozzle 681 via the gearbox lubrication system 651, flows to components of the fan actuation system 241 and the counterweight system 245, as depicted schematically by arrows in FIG. 8.

Similar to the fan assembly 238 of FIGS. 2 to 4, inner ends of the plurality of fan blade trunnions 272 of the fan actuation system 241 and inner ends of the counterweight trunnion portions 284 of the counterweight system 245 are in fluid communication with the forward sump cavity 360 of the fan assembly 638. As such, flow of the lubrication fluid 655 within the forward sump cavity 360 via the lubrication system 649 lubricates the fan blade trunnion bearings 274 and the fan blade shaft bearing members 326 of the fan actuation system 241 and the counterweight trunnion bearings 286 and the counterweight shaft bearing members 328 of the counterweight system 245.

In the illustrated embodiment, a portion of the lubrication fluid 655 from the first void area 360a of the forward sump cavity 360 of the fan assembly 638 flows through the aft sliding member 321 and a portion of the lubrication fluid 655 from the second void area 360b flows through the forward sliding member 319. In this way, the forward sliding member 319 and the aft sliding member 321 are directly lubricated by the lubrication fluid 655. In some embodiments, the actuator shaft 316 can define one or more channels that are configured to direct the lubrication fluid 655 from the first void area 360a and the second void area 360b to the forward sliding member 319 and the aft sliding member 321, respectively, while the actuator shaft 316 is in one of a plurality of axial positions along the fan assembly centerline axis 270 (FIG. 3).

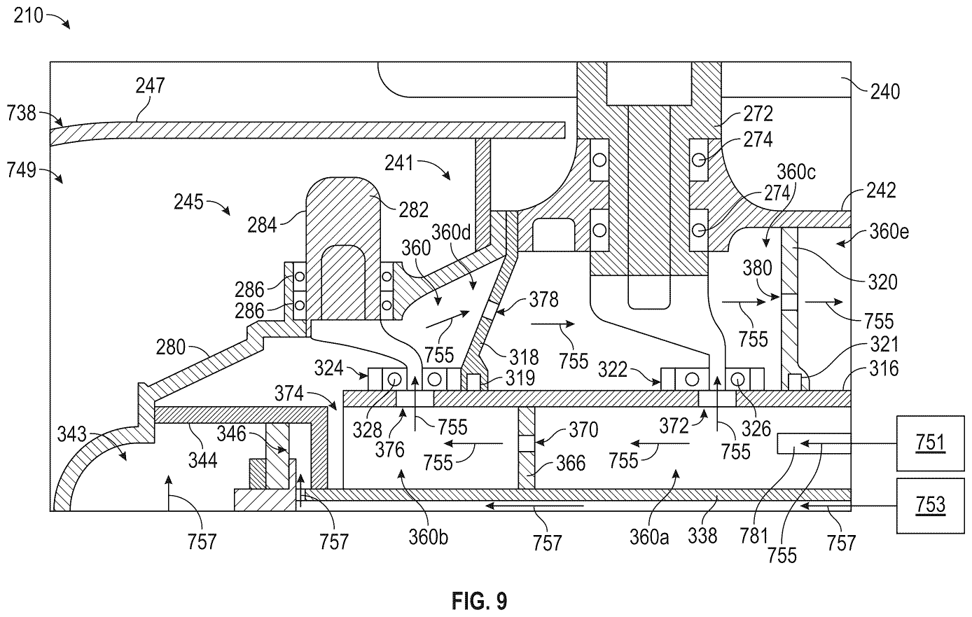

FIG. 9 is an enlarged, detailed, cross-sectional view of an exemplary fan assembly 738 and a lubrication system 749 of the turbine engine 210 of FIG. 2, taken along the longitudinal centerline axis 212 of the turbine engine 210, according to another embodiment of the present disclosure. The fan assembly 738 and the lubrication system 749 are substantially similar to the fan assembly 238 of FIGS. 2 to 4 and the lubrication system 249 of FIG. 5. The same reference numerals or similar reference numerals will be used for components of the fan assembly 738 and the lubrication system 749 that are the same as, or similar to, the components of the fan assembly 238 and the lubrication system 249 discussed above with regard to FIGS. 2 to 5. The description of such components of the fan assembly 238 and the lubrication system 249 above also applies to these components of the fan assembly 738 and the lubrication system 749, and a detailed description of these components is omitted here.

As shown in FIG. 9, in the illustrated embodiment, the lubrication system 749 includes a gearbox lubrication system 751 that provides a lubrication fluid 755 (e.g., oil) to the forward sump cavity 360 of the fan assembly 738 and a fan actuation system (FAS) lubrication system 753 that provides an actuation fluid 757 (e.g., oil) to the piston housing 344. Particularly, in the illustrated embodiment, the lubrication fluid 755 from the gearbox lubrication system 751 flows from the gearbox assembly 237 (FIG. 2) and into the forward sump cavity 360 via a nozzle 781 disposed within the first void area 360a. The fan assembly 738 and the lubrication system 749 are configured such that the lubrication fluid 755, as provided by the nozzle 781 via the gearbox lubrication system 751, flows to components of the fan actuation system 241 and the counterweight system 245, as depicted schematically by arrows in FIG. 9.

In the illustrated embodiment, inner ends of the plurality of fan blade trunnions 272 of the fan actuation system 241 and inner ends of the plurality of counterweight trunnion portions 284 of the counterweight system 245 are sealed from the forward sump cavity 360 of the fan assembly 738. Further, the lubrication fluid 755 is not provided directly to the forward sliding member 319 or the aft sliding member 321. In some embodiments, at least one of the inner ends of the plurality fan blade trunnions 272 or the inner ends of the plurality of counterweight trunnion portions 284 may be in fluid communication with the forward sump cavity 360.

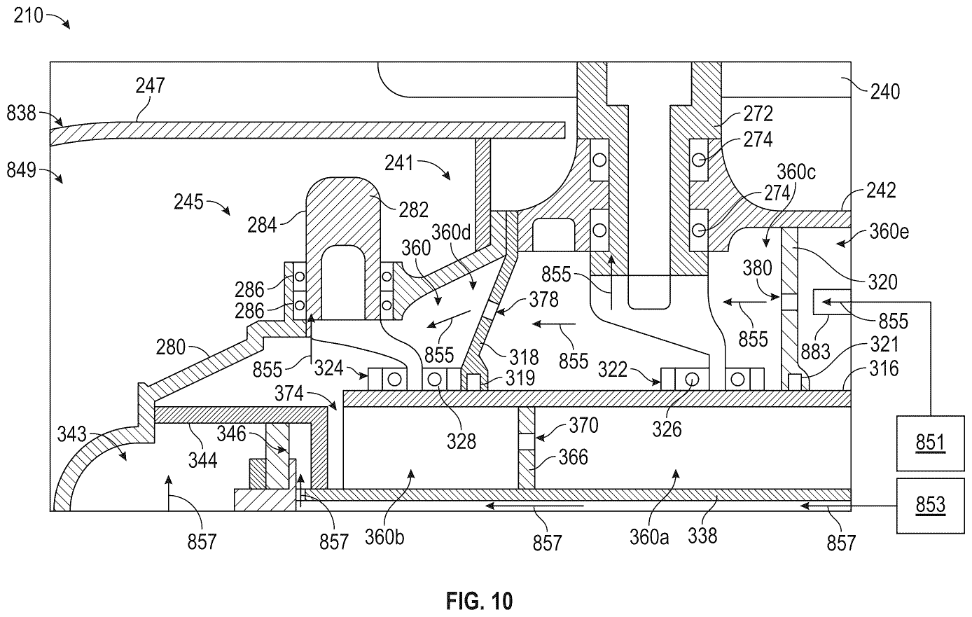

FIG. 10 is an enlarged, detailed, cross-sectional view of an exemplary fan assembly 838 and a lubrication system 849 of the turbine engine 210 of FIG. 2, taken along the longitudinal centerline axis 212 of the turbine engine 210, according to another embodiment of the present disclosure. The fan assembly 838 and the lubrication system 849 are substantially similar to the fan assembly 238 of FIGS. 2 to 4 and the lubrication system 249 of FIG. 5. The same reference numerals or similar reference numerals will be used for components of the fan assembly 838 and the lubrication system 849 that are the same as, or similar to, the components of the fan assembly 238 and the lubrication system 249 discussed above with regard to FIGS. 2 to 5. The description of such components of the fan assembly 238 and the lubrication system 249 above also applies to these components of the fan assembly 838 and the lubrication system 849, and a detailed description of these components is omitted here.

As shown in FIG. 10, in the illustrated embodiment, the lubrication system 849 includes a gearbox lubrication system 851 that provides a lubrication fluid 855 (e.g., oil) to the forward sump cavity 360 of the fan assembly 838 and a fan actuation system (FAS) lubrication system 853 that provides an actuation fluid 857 (e.g., oil) to the piston housing 344. Particularly, in the illustrated embodiment, the lubrication fluid 855 from the gearbox lubrication system 851 flows from the gearbox assembly 237 (FIG. 2) and into the forward sump cavity 360 via a fogger 883 disposed within the fifth void area 360e. The fan assembly 838 and the lubrication system 849 are configured such that the lubrication fluid 855, as provided by the fogger 883 via the gearbox lubrication system 851, flows to components of the fan actuation system 241 and the counterweight system 245, as depicted schematically by arrows in FIG. 10.

In the illustrated embodiment, the lubrication fluid 855 provided by the fogger 883 of the gearbox lubrication system 851 flows from the fifth void area 360e to the third void area 360c and then to the fourth void area 360d of the forward sump cavity 360. The lubrication fluid 855 in the fourth void area 360d can drain out of the fourth void area 360d through the second void area 360b and the first void area 360a. The fogger 883 is configured to distribute the lubrication fluid 855 as a mist to lubricate the fan actuation system 241 and the counterweight system 245 dispersed through the forward sump cavity 360. In this way, the gearbox lubrication system 851 can require a reduced supply of the lubrication fluid 855 as compared to other embodiments.

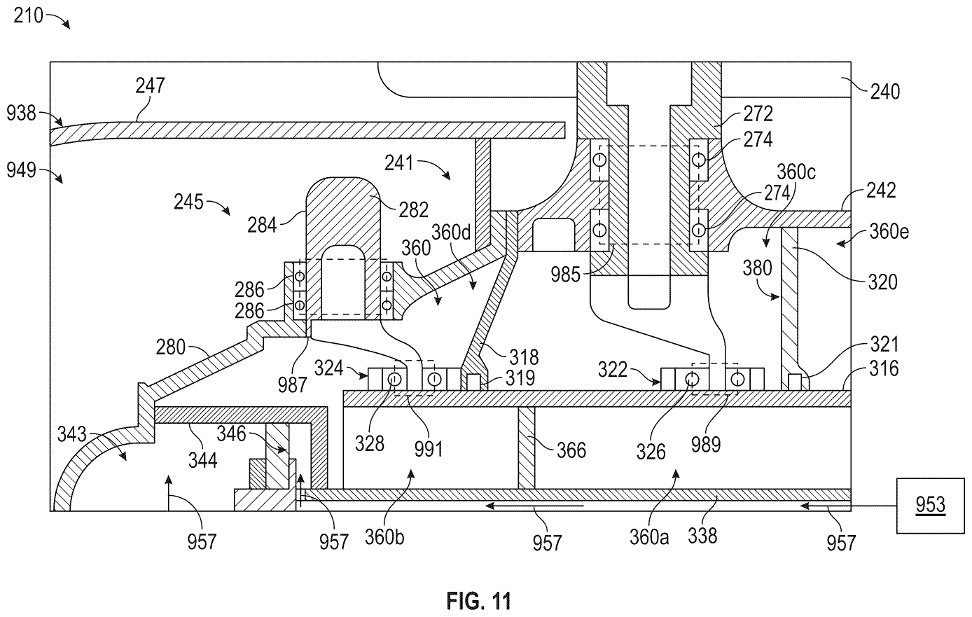

FIG. 11 is an enlarged, detailed, cross-sectional view of an exemplary fan assembly 938 and a lubrication system 949 of the turbine engine 210 of FIG. 2, taken along the longitudinal centerline axis 212 of the turbine engine 210, according to another embodiment of the present disclosure. The fan assembly 938 and the lubrication system 949 are substantially similar to the fan assembly 238 of FIGS. 2 to 4 and the lubrication system 249 of FIG. 5. The same reference numerals or similar reference numerals will be used for components of the fan assembly 938 and the lubrication system 949 that are the same as, or similar to, the components of the fan assembly 238 and the lubrication system 249 discussed above with regard to FIGS. 2 to 5. The description of such components of the fan assembly 238 and the lubrication system 249 above also applies to these components of the fan assembly 938 and the lubrication system 949, and a detailed description of these components is omitted here.

As shown in FIG. 11, the lubrication system 949 includes a fan actuation system (FAS) lubrication system 953 that provides an actuation fluid 957 (e.g., oil) to the piston housing 344 of the fan assembly 938. In the illustrated embodiment, the lubrication system 949 further includes a plurality of fan blade grease packs 985 that is arranged to provide lubrication to the fan blade trunnion bearings 274 of the plurality of fan blade trunnions 272 of the fan actuation system 241 and a plurality of counterweight grease packs 987 that is arranged to provide lubrication to the counterweight trunnion bearings 286 of the plurality of counterweight levers 282 of the counterweight system 245. Further, the lubrication system 949 also includes a plurality of blade crank arm grease packs 989 that is arranged to provide lubrication to the fan blade shaft bearing members 326 of the plurality of fan blade trunnions 272 of the fan actuation system 241 and a plurality of lever crank arm grease packs 991 that is arranged to provide lubrication to the counterweight shaft bearing members 328 of the plurality of counterweight levers 282 of the counterweight system 245.

Each of the plurality of fan blade grease packs 985, the plurality of counterweight grease packs 987, the plurality of blade crank arm grease packs 989, and the plurality of lever crank arm grease packs 991 of the lubrication system 949 is segregated or sealed from the forward sump cavity 360. In this way, the lubrication system 949 can provide lubrication to the fan blade trunnion bearings 274, the counterweight trunnion bearings 286, the fan blade shaft bearing members 326, and the counterweight shaft bearing members 328 without the flow of lubrication fluid through the forward sump cavity 360.

The plurality of fan blade grease packs 985, the plurality of counterweight grease packs 987, the plurality of blade crank arm grease packs 989, and the plurality of lever crank arm grease packs 991 may utilize one of a variety of types of greases. In some embodiments, the grease can be one of a mineral oil, a synthetic oil, a synthetic ester oil, or a synthetic diester oil.

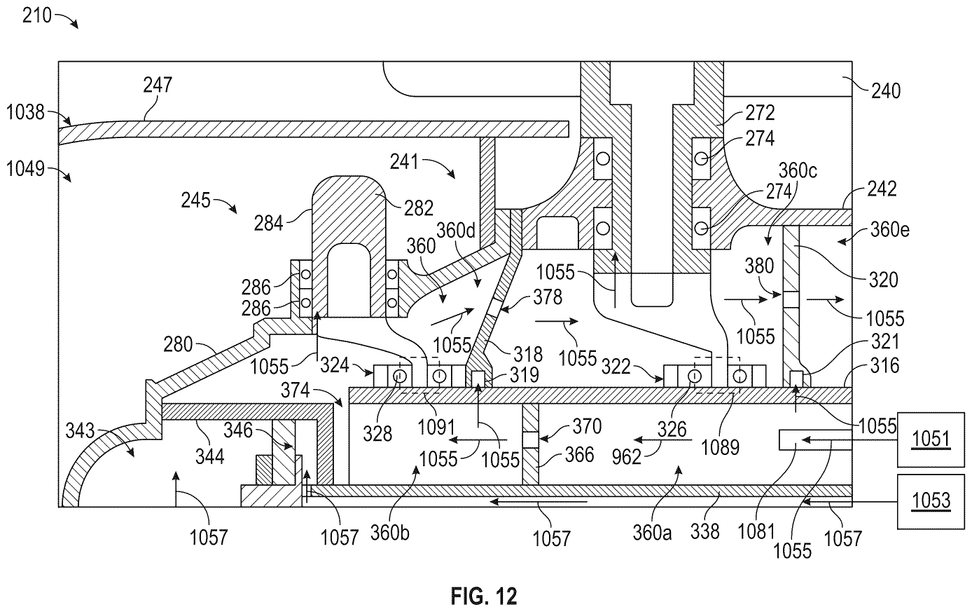

FIG. 12 is an enlarged, detailed, cross-sectional view of an exemplary fan assembly 1038 and a lubrication system 1049 of the turbine engine 210 of FIG. 2, taken along the longitudinal centerline axis 212 of the turbine engine 210, according to another embodiment of the present disclosure. The fan assembly 1038 and the lubrication system 1049 are substantially similar to the fan assembly 238 of FIGS. 2 to 4 and the lubrication system 249 of FIG. 5. The same reference numerals or similar reference numerals will be used for components of the fan assembly 1038 and the lubrication system 1049 that are the same as, or similar to, the components of the fan assembly 238 and the lubrication system 249 discussed above with regard to FIGS. 2 to 5. The description of such components of the fan assembly 238 and the lubrication system 249 above also applies to these components of the fan assembly 1038 and the lubrication system 1049, and a detailed description of these components is omitted here.

As shown in FIG. 12, in the illustrated embodiment, the lubrication system 1049 includes a gearbox lubrication system 1051 that provides a lubrication fluid 1055 (e.g., oil) to the forward sump cavity 360 of the fan assembly 1038 and a fan actuation system (FAS) lubrication system 1053 that provides an actuation fluid 1057 (e.g., oil) to the piston housing 344. Particularly, in the illustrated embodiment, the lubrication fluid 1055 from the gearbox lubrication system 1051 flows from the gearbox assembly 237 (FIG. 2) and into the forward sump cavity 360 via a nozzle 1081 disposed within the first void area 360a. The fan assembly 1038 and the lubrication system 1049 are configured such that the lubrication fluid 1055, as provided by the nozzle 1081 via the gearbox lubrication system 1051, flows to components of the fan actuation system 241 and the counterweight system 245, as depicted schematically by arrows in FIG. 12.

Similar to the fan assembly 238 of FIGS. 2 to 4, inner ends of the plurality of fan blade trunnions 272 of the fan actuation system 241 and inner ends of the plurality of counterweight trunnion portions 284 of the counterweight system 245 are in fluid communication with the forward sump cavity 360 of the fan assembly 1038. As such, flow of the lubrication fluid 1055 within the forward sump cavity 360 via the lubrication system 1049 lubricates the fan blade trunnion bearings 274 and the fan blade shaft bearing members 326 of the fan actuation system 241 and the counterweight trunnion bearings 286 and the counterweight shaft bearing members 328 of the counterweight system 245. In the illustrated embodiment, a portion of the lubrication fluid 1055 from the first void area 360a of the forward sump cavity 360 of the fan assembly 1038 flows through the aft sliding member 321 and a portion of the lubrication fluid 1055 from the second void area 360b flows through the forward sliding member 319. In this way, the forward sliding member 319 and the aft sliding member 321 are directly lubricated by the lubrication fluid 1055. In some embodiments, the actuator shaft 316 can define one or more channels that are configured to direct the lubrication fluid 1055 from the first void area 360a and the second void area 360b to the forward sliding member 319 and the aft sliding member 321, respectively, while the actuator shaft 316 is in one of a plurality of axial positions along the fan assembly centerline axis 270 (FIG. 3).

Referring still to FIG. 12, the lubrication system 1049 further includes a plurality of blade crank arm grease packs 1089 that is arranged to provide lubrication to the fan blade shaft bearing members 326 of the plurality of fan blade trunnions 272 of the fan actuation system 241 and a plurality of lever crank arm grease packs 1091 that is arranged to provide lubrication to the counterweight shaft bearing members 328 of the plurality of counterweight levers 282 of the counterweight system 245. The plurality of blade crank arm grease packs 1089 and the plurality of lever crank arm grease packs 1091 of the lubrication system 1049 are segregated or sealed from the forward sump cavity 360.

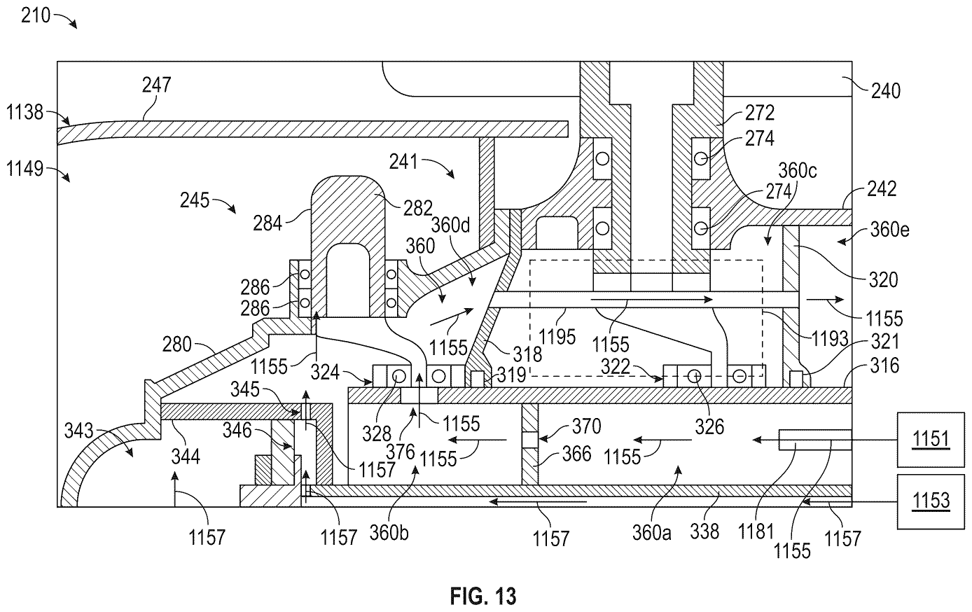

FIG. 13 is an enlarged, detailed, cross-sectional view of an exemplary fan assembly 1138 and a lubrication system 1149 of the turbine engine 210 of FIG. 2, taken along the longitudinal centerline axis 212 of the turbine engine 210, according to another embodiment of the present disclosure. The fan assembly 1138 and the lubrication system 1149 are substantially similar to the fan assembly 238 of FIGS. 2 to 4 and the lubrication system 249 of FIG. 5. The same reference numerals or similar reference numerals will be used for components of the fan assembly 1138 and the lubrication system 1149 that are the same as, or similar to, the components of the fan assembly 238 and the lubrication system 249 discussed above with regard to FIGS. 2 to 5. The description of such components of the fan assembly 238 and the lubrication system 249 above also applies to these components of the fan assembly 1138 and the lubrication system 1149, and a detailed description of these components is omitted here.

As shown in FIG. 13, in the illustrated embodiment, the lubrication system 1149 includes a gearbox lubrication system 1151 that provides a lubrication fluid 1155 (e.g., oil) to the forward sump cavity 360 of the fan assembly 1138 and a fan actuation system (FAS) lubrication system 1153 that provides an actuation fluid 1157 (e.g., oil) to the piston housing 344. Particularly, in the illustrated embodiment, the lubrication fluid 1155 from the gearbox lubrication system 1151 flows from the gearbox assembly 237 (FIG. 2) and into the forward sump cavity 360 via a nozzle 1181 disposed within the first void area 360a. The fan assembly 1138 and the lubrication system 1149 are configured such that the lubrication fluid 1155, as provided by the nozzle 1181 via the gearbox lubrication system 1151, flows to components of the fan actuation system 241 and the counterweight system 245, as depicted schematically by arrows in FIG. 13.

In the illustrated embodiment of FIG. 13, the third void area 360c of the forward sump cavity 360 of the fan assembly 1138 containing the fan actuation system 241 is segregated or sealed from the other void areas 360a, 360b, and 360d. A grease pack 1193 is arranged within the third void area 360c to provide lubrication of the fan actuation system 241 contained therein. The lubrication fluid 1155 is provided to the first void area 360a via the nozzle 1181 and flows through the first void area 360a and the second void area 360b to the fourth void area 360d to lubricate the counterweight system 245. A vent or a scavenge jumper tube 1195 fluidly connects the fourth void area 360d and the fifth void area 360e such that flow of the lubrication fluid 1155 bypasses the third void area 360c, as well as the grease pack 1193 and the fan actuation system 241 contained therein.

Further, the actuation fluid 1157 supplied to the piston housing 344 via the FAS lubrication system 1153 is permitted to leak from the piston housing 344 and into the fourth void area 360d, e.g., via a housing opening 345 defined in the piston housing 344. The actuation fluid 1157 can mix with the lubrication fluid 1155 in the fourth void area 360d and drain from the fourth void area 360d via the scavenge jumper tube 1195. In this way, the forward sump cavity 360 can be more tolerant to leaking of the actuation fluid 1157 from the piston housing 344.

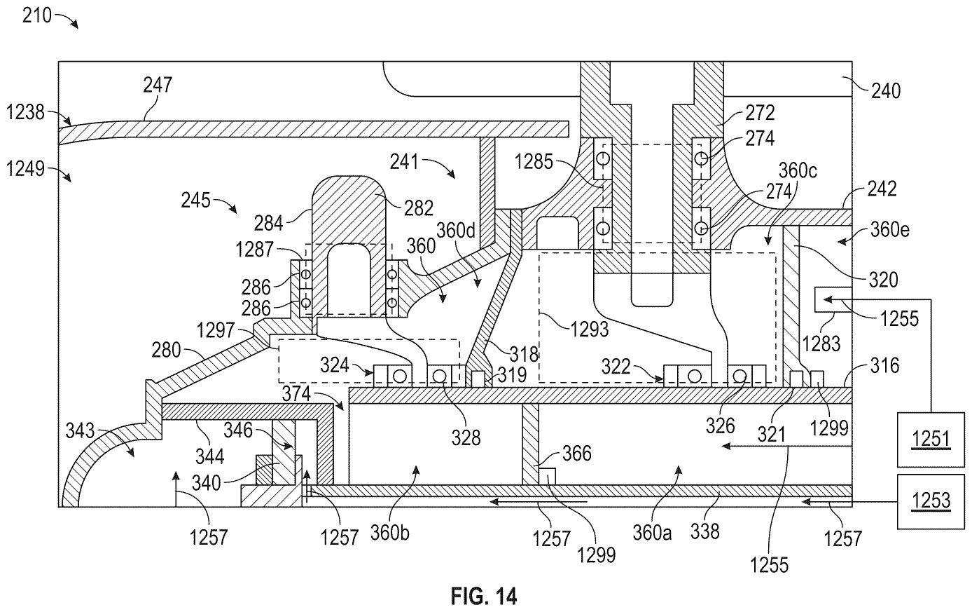

FIG. 14 is an enlarged, detailed, cross-sectional view of an exemplary fan assembly 1238 and a lubrication system 1249 of the turbine engine 210 of FIG. 2, taken along the longitudinal centerline axis 212 of the turbine engine 210, according to another embodiment of the present disclosure. The fan assembly 1238 and the lubrication system 1249 are substantially similar to the fan assembly 238 of FIGS. 2 to 4 and the lubrication system 249 of FIG. 5. The same reference numerals or similar reference numerals will be used for components of the fan assembly 1238 and the lubrication system 1249 that are the same as, or similar to, the components of the fan assembly 238 and the lubrication system 249 discussed above with regard to FIGS. 2 to 5. The description of such components of the fan assembly 238 and the lubrication system 249 above also applies to these components of the fan assembly 1238 and the lubrication system 1249, and a detailed description of these components is omitted here.

As shown in FIG. 14, in the illustrated embodiment, the lubrication system 1249 includes a gearbox lubrication system 1251 that provides a lubrication fluid 1255 (e.g., oil) to the forward sump cavity 360 of the fan assembly 1238 and a fan actuation system (FAS) lubrication system 1253 that provides an actuation fluid 1257 (e.g., oil) to the piston housing 344. Particularly, in the illustrated embodiment, the lubrication fluid 1255 from the gearbox lubrication system 1251 flows from the gearbox assembly 237 (FIG. 2) and into the forward sump cavity 360 via a fogger 1283 disposed within the fifth void area 360e. The fan assembly 1238 and the lubrication system 1249 are configured such that the lubrication fluid 1255, as provided by the fogger 1283 via the gearbox lubrication system 1251, flows to components of the fan actuation system 241 and the counterweight system 245, as depicted schematically by arrows in FIG. 14.

In the illustrated embodiment of FIG. 14, the lubrication system 1249 includes a first volume of grease 1293 contained within the third void area 360c to provide lubrication of the fan actuation system 241 contained therein and a second volume of grease 1297 contained within the fourth void area 360d to provide lubrication of the counterweight system contained therein. The lubrication system 1249 further includes a plurality of fan blade grease packs 1285 that is arranged to provide lubrication to the fan blade trunnion bearings 274 of the plurality of fan blade trunnions 272 of the fan actuation system 241 and a plurality of counterweight grease packs 1287 that is arranged to provide lubrication to the counterweight trunnion bearings 286 of the plurality of counterweight levers 282 of the counterweight system 245. Each of the plurality of fan blade grease packs 1285 and the plurality of counterweight grease packs 1287 is sealed off from each other and from the first volume of grease 1293, the second volume of grease 1297, and other portions of the forward sump cavity 360. The lubrication fluid 1255 provided to the fifth void area 360e via the fogger 1283 may flow into the first void area 360a.

In the illustrated embodiment, a plurality of sealing members 1299 is arranged in the forward sump cavity 360 to provide seals between the first volume of grease 1293 of the third void area 360c and the fifth void area 360e and seals between the second volume of grease 1297 of the fourth void area 360d (or the second void area 360b) and the first void area 360a. In some embodiments, the first volume of grease 1293 and the second volume of grease 1297 may be in fluid communication with each other. In some embodiments, the lubrication system 1249 can include one or more vents (not shown) to provide venting of one or both of the first volume of grease 1293 or the second volume of grease 1297 to the fifth void area 360e during operation of the turbine engine 219. For example, in some such embodiments, one or more vents may be defined by one or more of the forward shaft support 318, the aft shaft support 320, or the piston rod support 366.

In some embodiments, the first volume of grease 1293 may have a volume in a range of about twenty percent (20%) to about eighty percent (80%) of a volume of the third void area 360c, in a range of about thirty percent (30%) to about sixty percent (60%) of the volume of the third void area 360c, or in a range of about thirty-five percent (35%) to about fifty percent (50%) of the volume of the third void area 360c. In some embodiments, the first volume of grease 1293 may have a volume that is about forty percent (40%) of a volume of the third void area 360c. In some embodiments, the second volume of grease 1297 may have a volume in a range of about twenty percent (20%) to about eighty percent (80%) of a volume of the fourth void area 360d, in a range of about thirty percent (30%) to about sixty percent (60%) of the volume of the fourth void area 360d, or in a range of about thirty-five percent (35%) to about fifty percent (50%) of the volume of the fourth void area 360d. In some embodiments, the second volume of grease 1297 may have a volume that is about forty percent (40%) of a volume of the fourth void area 360d.

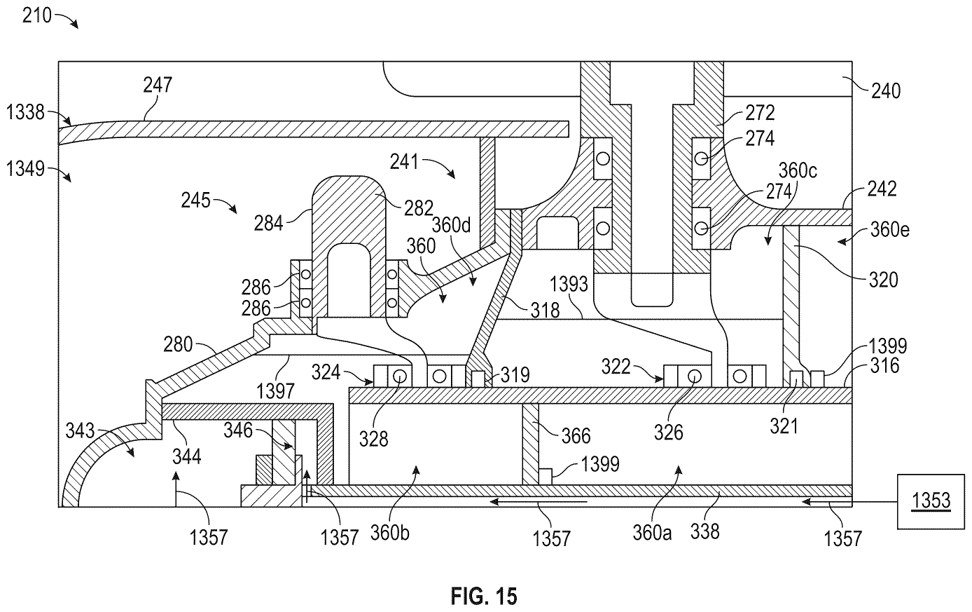

FIG. 15 is an enlarged, detailed, cross-sectional view of an exemplary fan assembly 1338 and a lubrication system 1349 of the turbine engine 210 of FIG. 2, taken along the longitudinal centerline axis 212 of the turbine engine 210, according to another embodiment of the present disclosure. The fan assembly 1338 and the lubrication system 1349 are substantially similar to the fan assembly 238 of FIGS. 2 to 4 and the lubrication system 249 of FIG. 5. The same reference numerals or similar reference numerals will be used for components of the fan assembly 1338 and the lubrication system 1349 that are the same as, or similar to, the components of the fan assembly 238 and the lubrication system 249 discussed above with regard to FIGS. 2 to 5. The description of such components of the fan assembly 238 and the lubrication system 249 above also applies to these components of the fan assembly 1338 and the lubrication system 1349, and a detailed description of these components is omitted here.

As shown in FIG. 15, the lubrication system 1349 includes a fan actuation system (FAS) lubrication system 1353 that provides actuation fluid 1357 (e.g., oil) to the piston housing 344 of the fan assembly 1338. In the illustrated embodiment, the lubrication system 1349 also includes a first volume of oil 1393 contained within the third void area 360c to provide lubrication of the fan actuation system 241 contained therein and a second volume of oil 1397 contained within the fourth void area 360d to provide lubrication of the counterweight system 245 contained therein.

Each of the first volume of oil 1393 and the second volume of oil 1397 is sealed off from each other and from other portions of the forward sump cavity 360 (e.g., the first void area 360a and the fifth void area 360e). For example, in the illustrated embodiment, a plurality of sealing members 1399 is arranged in the forward sump cavity 360 to provide a seal between the first volume of oil 1393 in the third void area 360c and the fifth void area 360e and a seal between the second volume of oil 1397 in the fourth void area 360d (or the second void area 360b) and the first void area 360a.

In the illustrated embodiment, the first volume of oil 1393 and the second volume of oil 1397 only partially fill the third void area 360c and the fourth void area 360d, respectively. Further, inner ends of the plurality of fan blade trunnions 272 of the fan actuation system 241 are in fluid communication with the third void area 360c and inner ends of the counterweight trunnion portions 284 of the counterweight system 245 are in fluid communication with the fourth void area 360d. In this way, with the forward sump cavity 360 rotating about the fan assembly centerline axis 270 (FIG. 3) during operation of the turbine engine 210, centrifugal forces cause the first volume of oil 1393 to flow outwardly within the third void area 360c and flood the plurality of fan blade trunnions 272 of the fan actuation system 241 and the second volume of oil 1397 to flow outwardly within the fourth void area 360d and flood the counterweight trunnion portions 284 of the counterweight system 245. Thus, during operation of the turbine engine 210, the first volume of oil 1393 lubricates the one or more fan blade trunnion bearings 274 of the fan actuation system 241 while the second volume of oil 1397 lubricates the one or more counterweight trunnion bearings 286 of the counterweight system 245.

In some embodiments, the first volume of oil 1393 may have a volume in a range of about ten percent (10%) to about ninety percent (90%) of a volume of the third void area 360c, in a range of about twenty percent (20%) to about sixty percent (60%) of the volume of the third void area 360c, or in a range of about thirty percent (30%) to about fifty percent (50%) of the volume of the third void area 360c. In some embodiments, the first volume of oil 1393 may have a volume that is less than about fifty percent (50%) of a volume of the third void area 360c. In some embodiments, the second volume of oil 1397 may have a volume in a range of about ten percent (10%) to about ninety percent (90%) of a volume of the fourth void area 360d, in a range of about twenty percent (20%) to about sixty percent (60%) of the volume of the fourth void area 360d, or in a range of about thirty percent (30%) to about fifty percent (50%) of the volume of the fourth void area 360d. In some embodiments, the second volume of oil 1397 may have a volume that is less than about fifty percent (50%) of a volume of the fourth void area 360d.

In some embodiments, the first volume of oil 1393 and the second volume of oil 1397 may be in fluid communication with each other. In some embodiments, the lubrication system 1349 can include one or more vents (not shown) to provide venting of one or both of the first volume of oil 1393 or the second volume of oil 1397 to the fifth void area 360e during operation of the turbine engine 219. For example, in some such embodiments, one or more vents may be defined by one or more of the forward shaft support 318, the aft shaft support 320, or the piston rod support 366.

Accordingly, the present disclosure provides for an improved lubrication system for a fan assembly of a turbine engine that lubricates one or both of a fan actuation system and a counterweight system of the fan assembly. Particularly, in some embodiments, the lubrication system provides lubrication fluid down a centerline axis of the turbine engine, which waterfalls through a sump cavity containing the fan actuation system and the counterweight system, lubricating components of the fan actuation system and the counterweight system. The lubrication fluid also fills cavities that house the fan blade trunnion bearings and the counterweight trunnion bearings of the fan actuation system and the counterweight system, respectively. When the cavities fill, excess lubrication fluid waterfalls to a scavenge feature. This configuration can utilize current oil systems of turbine engines and allows for the fan assembly to not have to carry the weight of grease in the system or have a large reservoir of stagnant oil. The fan assembly also provides an additional heat sink to remove heat from the lubrication system. Thus, flow of lubrication fluid can be increased through the sump cavity to reject more heat. In some embodiments, rotating housing structures of the fan assembly may be configured as functional heat sinks by incorporating certain materials and features such as fins. At the same time, addition of heat to the lubrication fluid from the turbine engine also keeps the sump cavity warm. This improves actuation the fan actuation system and helps to reduce friction at above ground altitudes.

Further aspects are provided by the subject matter of the following clauses.

A turbine engine including a turbo-engine, a fan section, and a lubrication system. The fan section is disposed upstream of the turbo-engine and defines a sump cavity. The fan section includes a fan assembly defining a fan assembly centerline axis that includes a fan shaft, a fan blade hub coupled to the fan shaft, a plurality of fan blades rotationally coupled to the fan blade hub, and a fan actuation system. The fan shaft is driven by the turbo-engine such that the fan shaft rotates about the fan assembly centerline axis. The fan blade hub partially defines the sump cavity such that the sump cavity rotates with the fan blade hub about the fan assembly centerline axis. The fan actuation system includes a plurality of fan blade trunnions that couple the plurality of fan blades to the fan blade hub and is configured to rotate the plurality of fan blades about a pitch axis relative to the fan blade hub. The lubrication system provides a lubrication fluid to the sump cavity such that, during operation of the turbine engine, the lubrication fluid flows through the sump cavity to lubricate the fan actuation system.

The turbine engine of the preceding clause, the lubrication system providing the lubrication fluid along the fan assembly centerline axis such that, during operation of the turbine engine, the lubrication fluid flows radially outward relative to the fan assembly centerline axis and through the sump cavity.

The turbine engine of any preceding clause, the fan actuation system further including a plurality of fan blade trunnion bearings arranged between the plurality of fan blade trunnions and the fan blade hub, the plurality of fan blade trunnions being in fluid communication with the sump cavity such that, during operation of the turbine engine, the lubrication fluid flows to the plurality of fan blade trunnion bearings.

The turbine engine of any preceding clause, the fan section further including a counterweight system that includes a counterweight hub that rotates about the fan assembly centerline axis during operation of the turbine engine and a plurality of counterweight levers rotationally connected to the counterweight hub. The counterweight hub and the fan blade hub at least partially defining the sump cavity.

The turbine engine of any preceding clause, during operation of the turbine engine, the lubrication fluid flows through the sump cavity and lubricates the fan actuation system and the counterweight system.

The turbine engine of any preceding clause, a plurality of counterweight trunnion bearings being arranged between a counterweight trunnion portion of each of the plurality of counterweight levers and the counterweight hub. The counterweight trunnion portions being in fluid communication with the sump cavity such that, during operation of the turbine engine, the lubrication fluid flows to the plurality of counterweight trunnion bearings.

The turbine engine of any preceding clause, each of the plurality of counterweight levers being coupled to the fan actuation system such that, when the fan actuation system rotates the plurality of fan blades relative to the fan blade hub, the plurality of counterweight levers rotates relative to the counterweight hub.

The turbine engine of any preceding clause, the fan actuation system further including an actuator shaft that is axially movable along the fan assembly centerline axis. The plurality of counterweight levers being rotationally coupled to the actuator shaft via a plurality of counterweight shaft bearing members such that the plurality of counterweight levers rotate relative to the counterweight hub as the actuator shaft moves axially. The plurality of counterweight shaft bearing members being arranged within the sump cavity such that, during operation of the turbine engine, the lubrication fluid flows through the plurality of counterweight shaft bearing members.

The turbine engine of any preceding clause, the fan actuation system further including an actuator shaft that is axially movable along the fan assembly centerline axis. Each of the plurality of fan blade trunnions being rotationally coupled to the actuator shaft via a plurality of fan blade shaft bearing members such that the plurality of fan blades rotate relative to the fan blade hub as the actuator shaft moves axially. The plurality of fan blade shaft bearing members being arranged within the sump cavity such that, during operation of the turbine engine, the lubrication fluid flows through the plurality of fan blade shaft bearing members.

The turbine engine of any preceding clause, the fan section further including a shaft support fixedly connected to the fan blade hub and a sliding member arranged between the shaft support and the actuator shaft to slidingly engage the actuator shaft as the actuator shaft moves axially along the fan assembly centerline axis. The sliding member being arranged within the sump cavity such that, during operation of the turbine engine, the lubrication fluid flows through the sliding member.

The turbine engine of any preceding clause, the fan actuation system further including a piston rod fixedly coupled to the actuator shaft. The lubrication system being further configured to move the piston rod and the actuator shaft axially along the fan assembly centerline axis.

The turbine engine of any preceding clause, a piston head being coupled to the piston rod and arranged within a piston housing. The lubrication system being configured to provide actuation fluid to the piston housing to cause the piston rod and the actuator shaft to move axially along the fan assembly centerline axis.

The turbine engine of any preceding clause, the actuation fluid from the piston housing being permitted to leak into the sump cavity.

The turbine engine of any preceding clause, the fan shaft being coupled to a low-pressure turbine of the turbo-engine via a gearbox assembly, and the lubrication system including a gearbox lubrication system that provides the lubrication fluid to the sump cavity.

The turbine engine of any preceding clause, the lubrication system further including a fan actuation system lubrication system that provides the actuation fluid to the piston housing. The actuation fluid from the piston housing being permitted to leak into the sump cavity.

The turbine engine of any preceding clause, the lubrication system further including a plurality of blade crank arm grease packs and the plurality of lever crank arm grease packs.

The turbine engine of any preceding clause, the lubrication system further including a plurality of fan blade grease packs and a plurality of counterweight grease packs.

The turbine engine of any preceding clause, the sump cavity including a plurality of void areas that includes a first void area, a second void area, a third void area, a fourth void area, and a fifth void area. During operation of the turbine engine, the lubrication fluid flows into the first void area to the second void area, then to the fourth void area to the third void area, and then to the fifth void area.

The turbine engine of any preceding clause, the first void area being defined by an actuator shaft of the fan actuation system.

The turbine engine of any preceding clause, the plurality of fan blade trunnions and the plurality of fan blade trunnion bearings being arranged in the third void area.

The turbine engine of any preceding clause, the plurality of fan blade shaft bearing members being arranged in the third void area.

The turbine engine of any preceding clause, during operation of the turbine engine, a portion of the lubrication fluid flows from the first void area into the third void area through the plurality of fan blade shaft bearing members.

The turbine engine of any preceding clause, the plurality of counterweight trunnion portions and the plurality of counterweight trunnion bearings being arranged in the fourth void area.

The turbine engine of any preceding clause, the plurality of counterweight shaft bearing members being arranged in the fourth void area.

The turbine engine of any preceding clause, during operation of the turbine engine, a portion of the lubrication fluid flows from the second void area into the fourth void area through the plurality of counterweight shaft bearing members.

The turbine engine of any preceding clause, the lubrication system further including a grease pack arranged within the third void area.

The turbine engine of any preceding clause, the lubrication system further including a vent jumper tube that fluidly connects the fourth void area and the fifth void area such that flow of the lubrication fluid through the sump cavity bypasses the third void area.

The turbine engine of any preceding clause, the lubrication system further including a first volume of grease disposed within the third void area and a second volume of grease disposed within the fourth void area.

The turbine engine of any preceding clause, the gearbox lubrication system including a nozzle disposed within the first void area.

The turbine engine of any preceding clause, the gearbox lubrication system including a fogger disposed within the fifth void area.

A turbine engine comprising a turbo-engine, a fan section disposed upstream of the turbo-engine and defining a sump cavity, and a lubrication system. The fan section including a fan assembly, a fan actuation system, and a counterweight system. The fan assembly defining a fan assembly centerline axis and including a fan shaft that is driven by the turbo-engine such that the fan shaft rotates about the fan assembly centerline axis, a fan blade hub coupled to the fan shaft, and a plurality of fan blades rotationally coupled to the fan blade hub. The fan actuation system including a plurality of fan blade trunnions that connect the plurality of fan blades to the fan blade hub and being configured to rotate the plurality of fan blades about a pitch axis relative to the fan blade hub. The counterweight system including a counterweight hub that rotates about the fan assembly centerline axis during operation of the turbine engine and a plurality of counterweight levers rotationally connected to the counterweight hub. The counterweight hub and the fan blade hub at least partially defining the sump cavity such that the sump cavity rotates about the fan assembly centerline axis during operation of the turbine engine. The lubrication system provides a lubrication fluid to the sump cavity such that, during operation of the turbine engine, the lubrication fluid flows through the sump cavity to lubricate at least one of the fan actuation system or the counterweight system.

The turbine engine of any preceding clause, the lubrication system providing the lubrication fluid along the fan assembly centerline axis such that, during operation of the turbine engine, the lubrication fluid flows radially outward relative to the fan assembly centerline axis and through the sump cavity.

The turbine engine of any preceding clause, the fan shaft being coupled to a low-pressure turbine of the turbo-engine via a gearbox assembly, and the lubrication system including a gearbox lubrication system that provides the lubrication fluid to the sump cavity.

The turbine engine of any preceding clause, during operation of the turbine engine, the lubrication fluid flowing through the sump cavity to lubricate the fan actuation system and the counterweight system.

The turbine engine of any preceding clause, the fan actuation system further including a plurality of fan blade trunnion bearings arranged between the plurality of fan blade trunnions and the fan blade hub. The plurality of fan blade trunnions being in fluid communication with the sump cavity such that, during operation of the turbine engine, the lubrication fluid flows to the plurality of fan blade trunnion bearings.

The turbine engine of any preceding clause, the counterweight system further including a plurality of counterweight trunnion bearings arranged between a counterweight trunnion portion of each of the plurality of counterweight levers and the counterweight hub. The counterweight trunnion portions being in fluid communication with the sump cavity such that, during operation of the turbine engine, the lubrication fluid flows to the plurality of counterweight trunnion bearings.

The turbine engine of any preceding clause, the lubrication system further including a plurality of blade crank arm grease packs and the plurality of lever crank arm grease packs.

The turbine engine of any preceding clause, the lubrication system further including a plurality of fan blade grease packs and a plurality of counterweight grease packs.

The turbine engine of any preceding clause, the sump cavity including a plurality of void areas that includes a first void area, a second void area, a third void area, a fourth void area, and a fifth void area. During operation of the turbine engine, the lubrication fluid flows into the first void area to the second void area, then to the fourth void area to the third void area, and then to the fifth void area.

The turbine engine of any preceding clause, the first void area being defined by an actuator shaft of the fan actuation system.

The turbine engine of any preceding clause, the plurality of fan blade trunnions and the plurality of fan blade trunnion bearings being arranged in the third void area.

The turbine engine of any preceding clause, the fan actuation system further including a plurality of fan blade shaft bearing members this is arranged in the third void area.

The turbine engine of any preceding clause, during operation of the turbine engine, a portion of the lubrication fluid flows from the first void area into the third void area through the plurality of fan blade shaft bearing members.

The turbine engine of any preceding clause, the plurality of counterweight trunnion portions and the plurality of counterweight trunnion bearings being arranged in the fourth void area.

The turbine engine of any preceding clause, the counterweight system further including a plurality of counterweight shaft bearing members that this is arranged in the fourth void area.

The turbine engine of any preceding clause, during operation of the turbine engine, a portion of the lubrication fluid flows from the second void area into the fourth void area through the plurality of counterweight shaft bearing members.

The turbine engine of any preceding clause, the lubrication system further including a grease pack arranged within the third void area.

The turbine engine of any preceding clause, the lubrication system further including a vent jumper tube that fluidly connects the fourth void area and the fifth void area such that flow of the lubrication fluid through the sump cavity bypasses the third void area.

The turbine engine of any preceding clause, the lubrication system further including a first volume of grease disposed within the third void area and a second volume of grease disposed within the fourth void area.

The turbine engine of any preceding clause, the gearbox lubrication system including a nozzle disposed within the first void area.

The turbine engine of any preceding clause, the gearbox lubrication system including a fogger disposed within the fifth void area.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbine engine comprising:
a turbo-engine;
a fan section disposed upstream of the turbo-engine and defining a sump cavity, the fan section comprising:
a fan assembly defining a fan assembly centerline axis, the fan assembly comprising a fan shaft that is driven by the turbo-engine such that the fan shaft rotates about the fan assembly centerline axis, a fan blade hub coupled to the fan shaft, and a plurality of fan blades rotationally coupled to the fan blade hub, the fan blade hub partially defining the sump cavity such that the sump cavity rotates with the fan blade hub about the fan assembly centerline axis; and
a fan actuation system comprising a plurality of fan blade trunnions that couples the plurality of fan blades to the fan blade hub, the fan actuation system being configured to rotate the plurality of fan blades about a pitch axis relative to the fan blade hub; and
a lubrication system that provides a lubrication fluid to the sump cavity such that, during operation of the turbine engine, the lubrication fluid flows through the sump cavity to lubricate the fan actuation system.

2. The turbine engine of claim 1, wherein the lubrication system provides the lubrication fluid along the fan assembly centerline axis such that, during operation of the turbine engine, the lubrication fluid flows radially outward relative to the fan assembly centerline axis and through the sump cavity.

3. The turbine engine of claim 1, wherein the fan actuation system further comprises a plurality of fan blade trunnion bearings arranged between the plurality of fan blade trunnions and the fan blade hub, the plurality of fan blade trunnions being in fluid communication with the sump cavity such that, during operation of the turbine engine, the lubrication fluid flows to the plurality of fan blade trunnion bearings.

4. The turbine engine of claim 1, wherein the fan section further comprises a counterweight system, the counterweight system comprising a counterweight hub that rotates about the fan assembly centerline axis during operation of the turbine engine and a plurality of counterweight levers rotationally connected to the counterweight hub, the counterweight hub and the fan blade hub at least partially defining the sump cavity.

5. The turbine engine of claim 4, wherein, during operation of the turbine engine, the lubrication fluid flows through the sump cavity and lubricates the fan actuation system and the counterweight system.

6. The turbine engine of claim 5, wherein a plurality of counterweight trunnion bearings is arranged between a counterweight trunnion portion of each of the plurality of counterweight levers and the counterweight hub, the counterweight trunnion portions being in fluid communication with the sump cavity such that, during operation of the turbine engine, the lubrication fluid flows to the plurality of counterweight trunnion bearings.

7. The turbine engine of claim 6, wherein each of the plurality of counterweight levers is coupled to the fan actuation system such that, when the fan actuation system rotates the plurality of fan blades relative to the fan blade hub, the plurality of counterweight levers rotates relative to the counterweight hub.

8. The turbine engine of claim 7, wherein the fan actuation system further comprises an actuator shaft that is axially movable along the fan assembly centerline axis, the plurality of counterweight levers being rotationally coupled to the actuator shaft via a plurality of counterweight shaft bearing members such that the plurality of counterweight levers rotate relative to the counterweight hub as the actuator shaft moves axially, the plurality of counterweight shaft bearing members being arranged within the sump cavity such that, during operation of the turbine engine, the lubrication fluid flows through the plurality of counterweight shaft bearing members.

9. The turbine engine of claim 1, wherein the fan actuation system further comprises an actuator shaft that is axially movable along the fan assembly centerline axis, each of the plurality of fan blade trunnions being rotationally coupled to the actuator shaft via a plurality of fan blade shaft bearing members such that the plurality of fan blades rotate relative to the fan blade hub as the actuator shaft moves axially, the plurality of fan blade shaft bearing members being arranged within the sump cavity such that, during operation of the turbine engine, the lubrication fluid flows through the plurality of fan blade shaft bearing members.

10. The turbine engine of claim 9, wherein the fan section further comprises a shaft support fixedly connected to the fan blade hub and a sliding member arranged between the shaft support and the actuator shaft to slidingly engage the actuator shaft as the actuator shaft moves axially along the fan assembly centerline axis, the sliding member being arranged within the sump cavity such that, during operation of the turbine engine, the lubrication fluid flows through the sliding member.

11. The turbine engine of claim 9, wherein the fan actuation system further comprises a piston rod fixedly coupled to the actuator shaft, and the lubrication system being further configured to move the piston rod and the actuator shaft axially along the fan assembly centerline axis.

12. The turbine engine of claim 11, wherein a piston head is coupled to the piston rod and arranged within a piston housing, the lubrication system being configured to provide actuation fluid to the piston housing to cause the piston rod and the actuator shaft to move axially along the fan assembly centerline axis.

13. The turbine engine of claim 12, wherein the actuation fluid from the piston housing is permitted to leak into the sump cavity.

14. The turbine engine of claim 12, wherein the fan shaft is coupled to a low-pressure turbine of the turbo-engine via a gearbox assembly, and
wherein the lubrication system comprises a gearbox lubrication system that provides the lubrication fluid to the sump cavity.

15. The turbine engine of claim 14, wherein the lubrication system further comprises a fan actuation system lubrication system that provides the actuation fluid to the piston housing, the actuation fluid from the piston housing being permitted to leak into the sump cavity.

16. A turbine engine comprising:
a turbo-engine;
a fan section disposed upstream of the turbo-engine and defining a sump cavity, the fan section comprising:
a fan assembly defining a fan assembly centerline axis, the fan assembly comprising a fan shaft that is driven by the turbo-engine such that the fan shaft rotates about the fan assembly centerline axis, a fan blade hub coupled to the fan shaft, and a plurality of fan blades rotationally coupled to the fan blade hub;
a fan actuation system comprising a plurality of fan blade trunnions that connects the plurality of fan blades to the fan blade hub, the fan actuation system being configured to rotate the plurality of fan blades about a pitch axis relative to the fan blade hub; and
a counterweight system comprising a counterweight hub that rotates about the fan assembly centerline axis during operation of the turbine engine and a plurality of counterweight levers rotationally connected to the counterweight hub, the counterweight hub and the fan blade hub at least partially defining the sump cavity such that the sump cavity rotates about the fan assembly centerline axis during operation of the turbine engine; and
a lubrication system that provides a lubrication fluid to the sump cavity such that, during operation of the turbine engine, the lubrication fluid flows through the sump cavity to lubricate at least one of the fan actuation system or the counterweight system.

17. The turbine engine of claim 16, wherein the lubrication system provides the lubrication fluid along the fan assembly centerline axis such that, during operation of the turbine engine, the lubrication fluid flows radially outward relative to the fan assembly centerline axis and through the sump cavity.

18. The turbine engine of claim 16, wherein the fan shaft is coupled to a low-pressure turbine of the turbo-engine via a gearbox assembly, and
wherein the lubrication system comprises a gearbox lubrication system that provides the lubrication fluid to the sump cavity.

19. The turbine engine of claim 16, wherein, during operation of the turbine engine, the lubrication fluid flows through the sump cavity to lubricate the fan actuation system and the counterweight system.

20. The turbine engine of claim 19, wherein the fan actuation system further comprises a plurality of fan blade trunnion bearings arranged between the plurality of fan blade trunnions and the fan blade hub, the plurality of fan blade trunnions being in fluid communication with the sump cavity such that, during operation of the turbine engine, the lubrication fluid flows to the plurality of fan blade trunnion bearings, and
wherein the counterweight system further comprises a plurality of counterweight trunnion bearings arranged between a counterweight trunnion portion of each of the plurality of counterweight levers and the counterweight hub, the counterweight trunnion portions being in fluid communication with the sump cavity such that, during operation of the turbine engine, the lubrication fluid flows to the plurality of counterweight trunnion bearings.
